(19) United States
(12) Patent Application Publication
(10) Pub. No.: US 2026/0017833 A1
(43) Pub. Date: Jan. 15, 2026

(54) LIFTING PARAMETER SYNTAX REFINEMENTS FOR V-DMC

(71) Applicant: QUALCOMM Incorporated, San Diego, CA (US)

(72) Inventors: Geert Van der Auwera, San Diego, CA (US); Adarsh Krishnan Ramasubramonian, Irvine, CA (US); Reetu Hooda, San Diego, CA (US); Anique Akhtar, San Diego, CA (US); Marta Karczewicz, San Diego, CA (US)

(21) Appl. No.: 19/263,041

(22) Filed: Jul. 8, 2025

Related U.S. Application Data
(60) Provisional application No. 63/669,616, filed on Jul. 10, 2024.
(60) Provisional application No. 63/711,545, filed on Oct. 24, 2024.

(51) Int. Cl. G06T 9/00; H04N 19/119; H04N 19/169; H04N 19/70

(52) U.S. Cl. CPC G06T 9/001; H04N 19/119; H04N 19/1883; H04N 19/70

(57) ABSTRACT

A device for decoding encoded mesh data is configured to receive a first flag, wherein a first value of the first flag indicates lifting transform parameters are to be updated and a second value for the flag indicates the lifting transform parameters are not to be updated; receive a second flag in response to the first flag being equal to the first value, wherein a first value for the second flag indicates lifting transform parameters are signaled at a level of detail (LoD) level and a second value for the second flag indicates the lifting transform parameters are not signaled at the LoD level; update the lifting transform parameters in response to the second flag being equal to the second value; determine updated lifting transform parameters based on the lifting transform parameters; and determine displacement vectors based on the updated lifting transform parameters.

This application claims the benefit of
U.S. Provisional Patent Application No. 63/711,545, filed 24 Oct. 2024, and
U.S. Provisional Patent Application No. 63/669,616, filed 10 Jul. 2024,
   the entire content of each application being incorporated herein by reference.

### TECHNICAL FIELD

This disclosure relates to video-based coding of dynamic meshes.

### BACKGROUND

Meshes may be used to represent physical content of a 3-dimensional space. Meshes may have utility in a wide variety of situations. For example, meshes may be used in the context of representing the physical content of an environment for purposes of positioning virtual objects in an extended reality, e.g., augmented reality (AR), virtual reality (VR), or mixed reality (MR), application. Mesh compression is a process for encoding and decoding meshes. Encoding meshes may reduce the amount of data required for storage and transmission of the meshes.

### SUMMARY

This disclosure describes techniques to improve the signaling of displacement vectors and, more specifically, to the signaling of VDMC lifting transform parameters (VLTPs). By receiving a first flag, where a first value of the first flag indicates that the one or more lifting parameters are to be updated and a second value for the flag indicates that the one or more lifting parameters are not to be updated, and receiving a second flag in response to the first flag being equal to the first value, wherein a first value for the second flag indicates that lifting transform parameters are signaled at a level of detail (LoD) level and a second value for the second flag indicates that the lifting transform parameters are not signaled at the LoD level, the techniques of this disclosure may maintain flexibility for updating lifting parameters without significantly increase signaling overhead.

According to an example of this disclosure, a device for decoding encoded mesh data includes: one or more memory units; one or more processing units implemented in circuitry, coupled to the one or more memory units, and configured to: determine, based on the encoded mesh data, a base mesh with a first set of vertices; subdivide the base mesh to determine an additional set of vertices for the base mesh; receive a first flag, wherein a first value of the first flag indicates that one or more lifting transform parameters are to be updated and a second value for the flag indicates that the one or more lifting transform parameters are not to be updated; receive a second flag in response to the first flag being equal to the first value, wherein a first value for the second flag indicates that lifting transform parameters are signaled at a level of detail (LoD) level and a second value for the second flag indicates that the lifting transform parameters are not signaled at the LoD level; update the one or more lifting transform parameters in response to the second flag being equal to the second value; determine one or more updated lifting transform parameters based on the lifting transform parameters; determine one or more displacement vectors based on the one or more updated lifting transform parameters; deform the base mesh, wherein to deform the base mesh, the one more processing units are configured to modify locations of the additional set of vertices based on the one or more displacement vectors; and determine a decoded mesh based on the deformed base mesh.

According to an example of this disclosure, a method for decoding encoded mesh data includes: determining, based on the encoded mesh data, a base mesh with a first set of vertices; subdividing the base mesh to determine an additional set of vertices for the base mesh; determining one or more lifting transform parameters, wherein determining the one or more lifting transform parameters comprises: receiving a first flag, wherein a first value of the first flag indicates that the one or more lifting transform parameters are to be updated and a second value for the flag indicates that the one or more lifting transform parameters are not to be updated; receiving a second flag in response to the first flag being equal to the first value, wherein a first value for the second flag indicates that lifting transform parameters are signaled at a level of detail (LoD) level and a second value for the second flag indicates that the lifting transform parameters are not signaled at the LoD level; updating the one or more lifting transform parameters in response to the second flag being equal to the second value; and determining one or more updated lifting transform parameters based on the lifting transform parameters; determining one or more displacement vectors based on the one or more updated lifting transform parameters; deforming the base mesh, wherein to deform the base mesh, the one more processing units are configured to modify locations of the additional set of vertices based on the one or more displacement vectors; and determining a decoded mesh based on the deformed base mesh.

A computer-readable storage medium stores instructions that when executed by one or more processors causes the one or more processors to: determine, based on the encoded mesh data, a base mesh with a first set of vertices; subdivide the base mesh to determine an additional set of vertices for the base mesh; determine one or more lifting transform parameters, wherein to determine the one or more lifting transform parameters, the instructions cause the one or more processors to: receive a first flag, wherein a first value of the first flag indicates that the one or more lifting transform parameters are to be updated and a second value for the flag indicates that the one or more lifting transform parameters are not to be updated; receive a second flag in response to the first flag being equal to the first value, wherein a first value for the second flag indicates that lifting transform parameters are signaled at a level of detail (LoD) level and a second value for the second flag indicates that the lifting transform parameters are not signaled at the LoD level; update the one or more lifting transform parameters in response to the second flag being equal to the second value; and determine one or more updated lifting transform parameters based on the lifting transform parameters; determine one or more displacement vectors based on the one or more updated lifting transform parameters; deform the base mesh, wherein to deform the base mesh, the one more processing units are configured to modify locations of the additional set of vertices based on the one or more displacement vectors; and determine a decoded mesh based on the deformed base mesh.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example encoding and decoding system that may perform the techniques of this disclosure.

FIG. 2 shows an example implementation of a V-DMC encoder.

FIG. 3 shows an example implementation of a V-DMC decoder.

FIG. 4 shows an example of resampling to enable efficient compression of a 2D curve.

FIG. 5 shows a displaced curve that has a subdivision structure, while approximating the shape of the original mesh.

FIG. 6 shows a block diagram of a pre-processing system.

FIG. 7 shows an example of a V-DMC intra frame encoder.

FIG. 8 shows an example of a V-DMC decoder.

FIG. 9 shows an example of a V-DMC intra frame decoder.

FIG. 10 shows an example of a mid-point division scheme.

FIG. 11 is a flowchart illustrating an example process for encoding a mesh.

FIG. 12 is a flowchart illustrating an example process for decoding a compressed bitstream of mesh data.

FIG. 13 is a flowchart illustrating an example process for decoding a compressed bitstream of mesh data.

### DETAILED DESCRIPTION

A mesh generally refers to a collection of vertices in a three-dimensional (3D) space that collectively represent one or multiple objects in the 3D space. The vertices are connected by edges, and the edges form polygons, which form faces of the mesh. Each vertex may also have one or more associated attributes, such as a texture or a color. In most scenarios, having more vertices produces higher quality, e.g., more detailed and more realistic, meshes. Having more vertices, however, also requires more data to represent the mesh.

To reduce the amount of data needed to represent the mesh, the mesh may be encoded using lossy or lossless encoding. In lossless encoding, the decoded version of the encoded mesh exactly matches the original mesh. In lossy encoding, by contrast, the process of encoding and decoding the mesh causes loss, such as distortion, in the decoded version of the encoded mesh.

In one example of a lossy encoding technique for meshes, a mesh encoder decimates an original mesh to determine a base mesh. To decimate the original mesh, the mesh encoder subsamples or otherwise reduces the number of vertices in the original mesh, such that the base mesh is a rough approximation, with fewer vertices, of the original mesh. The mesh encoder then subdivides the decimated mesh. That is the mesh encoder estimates the locations of additional vertices in between the vertices of the base mesh. The mesh encoder then deforms the subdivided mesh by moving the vertices in a manner that makes the deformed mesh more closely match the original mesh.

After determining a desired base mesh and deformation of the subdivided mesh, the mesh encoder generates a bitstream that includes data for constructing the base mesh and data for performing the deformation. The data defining the deformation may be signaled as a series of displacement vectors that indicate the movement, or displacement, of the additional vertices determined by the subdividing process. To decode a mesh from the bitstream, a mesh decoder reconstructs the base mesh based on the signaled information, applies the same subdivision process as the mesh encoder, and then displaces the additional vertices based on the signaled displacement vectors.

This disclosure describes techniques to improve the signaling of displacement vectors and, more specifically, to the signaling of VDMC lifting transform parameters (VLTPs). By receiving a first flag, where a first value of the first flag indicates that the one or more lifting parameters are to be updated and a second value for the flag indicates that the one or more lifting parameters are not to be updated, and receiving a second flag in response to the first flag being equal to the first value, wherein a first value for the second flag indicates that lifting transform parameters are signaled at a level of detail (LoD) level and a second value for the second flag indicates that the lifting transform parameters are not signaled at the LoD level, the techniques of this disclosure may maintain flexibility for updating lifting parameters without significantly increase signaling overhead.

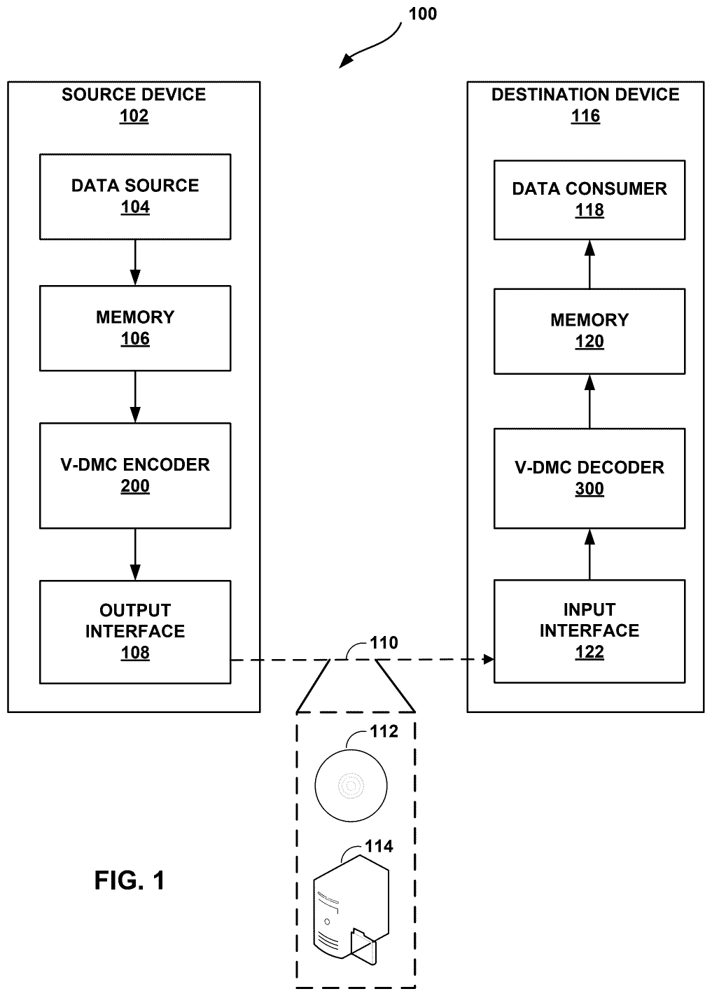

FIG. 1 is a block diagram illustrating an example encoding and decoding system 100 that may perform the techniques of this disclosure. The techniques of this disclosure are generally directed to coding (encoding and/or decoding) meshes. The coding may be effective in compressing and/or decompressing data of the meshes.

As shown in FIG. 1, system 100 includes a source device 102 and a destination device 116. Source device 102 provides encoded data to be decoded by a destination device 116. Particularly, in the example of FIG. 1, source device 102 provides the data to destination device 116 via a computer-readable medium 110. Source device 102 and destination device 116 may comprise any of a wide range of devices, including desktop computers, notebook (i.e., laptop) computers, tablet computers, set-top boxes, telephone handsets such as smartphones, televisions, cameras, display devices, digital media players, video gaming consoles, video streaming devices, terrestrial or marine vehicles, spacecraft, aircraft, robots, LIDAR devices, satellites, or the like. In some cases, source device 102 and destination device 116 may be equipped for wireless communication.

In the example of FIG. 1, source device 102 includes a data source 104, a memory 106, a V-DMC encoder 200, and an output interface 108. Destination device 116 includes an input interface 122, a V-DMC decoder 300, a memory 120, and a data consumer 118. In accordance with this disclosure, V-DMC encoder 200 of source device 102 and V-DMC decoder 300 of destination device 116 may be configured to apply the techniques of this disclosure related to displacement vector quantization. Thus, source device 102 represents an example of an encoding device, while destination device 116 represents an example of a decoding device. In other examples, source device 102 and destination device 116 may include other components or arrangements. For example, source device 102 may receive data from an internal or external source. Likewise, destination device 116 may interface with an external data consumer, rather than include a data consumer in the same device.

System 100 as shown in FIG. 1 is merely one example. In general, other digital encoding and/or decoding devices may perform the techniques of this disclosure related to displacement vector quantization. Source device 102 and destination device 116 are merely examples of such devices in which source device 102 generates coded data for transmission to destination device 116. This disclosure refers to a “coding” device as a device that performs coding (encoding and/or decoding) of data. Thus, V-DMC encoder 200 and V-DMC decoder 300 represent examples of coding devices, in particular, an encoder and a decoder, respectively. In some examples, source device 102 and destination device 116 may operate in a substantially symmetrical manner such that each of source device 102 and destination device 116 includes encoding and decoding components. Hence, system 100 may support one-way or two-way transmission between source device 102 and destination device 116, e.g., for streaming, playback, broadcasting, telephony, navigation, and other applications.

In general, data source 104 represents a source of data (e.g., raw, unencoded data) and may provide a sequential series of “frames” of the data to V-DMC encoder 200, which encodes data for the frames. Data source 104 may, for example, execute a framework or platform for generating graphics for video games, augmented reality, simulations, or any other such use case. Data source 104 of source device 102 may include a graphics engine that generates raw mesh data from any combination of one or more sensors configured to obtain real-world data. Examples of such sensors include cameras, 2D scanners, 3D scanners, light detection and ranging (LIDAR) devices, video cameras, ultrasonic sensors, infrared sensors, inertial measurement sensors, sonar sensors, pressure sensors, thermal imaging sensors, magnetic sensors, laser range finders, photodetectors, and the like. In other examples, the graphics engine may generate meshes that are entirely computer generated, i.e., not representative of a real world scene, using modeling, simulation, animation, generative adversarial networks, and the like. In yet other examples, data source 104 may not include a graphics engine, but instead, may obtain the mesh data from a storage unit or other device.

Regardless of whether the mesh data is based on real-world sensor data, entirely computer generated, obtained from an external source, or some combination thereof, V-DMC encoder 200 encodes the mesh data. V-DMC encoder 200 may rearrange the frames from the received order (sometimes referred to as “display order”) into a coding order for coding. V-DMC encoder 200 may generate one or more bitstreams including encoded data. Source device 102 may then output the encoded data via output interface 108 onto computer-readable medium 110 for reception and/or retrieval by, e.g., input interface 122 of destination device 116.

Memory 106 of source device 102 and memory 120 of destination device 116 may represent general purpose memories. In some examples, memory 106 and memory 120 may store raw data, e.g., raw data from data source 104 and raw, decoded data from V-DMC decoder 300. Additionally or alternatively, memory 106 and memory 120 may store software instructions executable by, e.g., V-DMC encoder 200 and V-DMC decoder 300, respectively. Although memory 106 and memory 120 are shown separately from V-DMC encoder 200 and V-DMC decoder 300 in this example, it should be understood that V-DMC encoder 200 and V-DMC decoder 300 may also include internal memories for functionally similar or equivalent purposes. Furthermore, memory 106 and memory 120 may store encoded data, e.g., output from V-DMC encoder 200 and input to V-DMC decoder 300. In some examples, portions of memory 106 and memory 120 may be allocated as one or more buffers, e.g., to store raw, decoded, and/or encoded data. For instance, memory 106 and memory 120 may store data representing a mesh.

Computer-readable medium 110 may represent any type of medium or device capable of transporting the encoded data from source device 102 to destination device 116. In one example, computer-readable medium 110 represents a communication medium to enable source device 102 to transmit encoded data directly to destination device 116 in real-time, e.g., via a radio frequency network or computer-based network. Output interface 108 may modulate a transmission signal including the encoded data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded data.

In some examples, source device 102 may output encoded data to file server 114 or another intermediate storage device that may store the encoded data generated by source device 102. Destination device 116 may access stored data from file server 114 via streaming or download. File server 114 may be any type of server device capable of storing encoded data and transmitting that encoded data to the destination device 116. File server 114 may represent a web server (e.g., for a website), a File Transfer Protocol (FTP) server, a content delivery network device, or a network attached storage (NAS) device. Destination device 116 may access encoded data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded data stored on file server 114. File server 114 and input interface 122 may be configured to operate according to a streaming transmission protocol, a download transmission protocol, or a combination thereof.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to V-DMC encoder 200 and/or output interface 108, and destination device 116 may include an SoC device to perform the functionality attributed to V-DMC decoder 300 and/or input interface 122.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

Input interface 122 of destination device 116 receives an encoded bitstream from computer-readable medium 110 (e.g., a communication medium, storage device 112, file server 114, or the like). The encoded bitstream may include signaling information defined by V-DMC encoder 200, which is also used by V-DMC decoder 300, such as syntax elements having values that describe characteristics and/or processing of coded units (e.g., slices, pictures, groups of pictures, sequences, or the like). Data consumer 118 uses the decoded data. For example, data consumer 118 may use the decoded data to determine the locations of physical objects. In some examples, data consumer 118 may comprise a display to present imagery based on meshes.

V-DMC encoder 200 and V-DMC decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of V-DMC encoder 200 and V-DMC decoder 300 may be included in one or more encoders or decoders, either of which may be integrated as part of a combined encoder/decoder (CODEC) in a respective device. A device including V-DMC encoder 200 and/or V-DMC decoder 300 may comprise one or more integrated circuits, microprocessors, and/or other types of devices.

V-DMC encoder 200 and V-DMC decoder 300 may operate according to a coding standard. This disclosure may generally refer to coding (e.g., encoding and decoding) of pictures to include the process of encoding or decoding data. An encoded bitstream generally includes a series of values for syntax elements representative of coding decisions (e.g., coding modes).

This disclosure may generally refer to “signaling” certain information, such as syntax elements. The term “signaling” may generally refer to the communication of values for syntax elements and/or other data used to decode encoded data. That is, V-DMC encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

This disclosure addresses various improvements of the displacement vector quantization process in the video-based coding of dynamic meshes (V-DMC) technology that is being standardized in MPEG WG7 (3DGH).

The MPEG working group 6 (WG7), also known as the 3D graphics and haptics coding group (3DGH), is currently standardizing the video-based coding of dynamic mesh representations (V-DMC) targeting XR use cases. The current test model is based on the call for proposals result, Khaled Mammou, Jungsun Kim, Alexandros Tourapis, Dimitri Podborski, Krasimir Kolarov, [V-CG] Apple's Dynamic Mesh Coding CfP Response, ISO/IEC JTC1/SC29/WG7, m59281, April 2022, and encompasses the pre-processing of the input meshes into approximated meshes with typically fewer vertices named the base meshes, which are coded with a static mesh coder (cfr. Draco, etc.). In addition, the encoder may estimate the motion of the base mesh vertices and code the motion vectors into the bitstream. The reconstructed base meshes may be subdivided into finer meshes with additional vertices and, hence, additional triangles. The encoder may refine the positions of the subdivided mesh vertices to approximate the original mesh. The refinements or vertex displacement vectors may be coded into the bitstream. In the current test model, the displacement vectors are wavelet transformed, quantized, and the coefficients are packed into a 2D frame. The sequence of frames is coded with a typical video coder, for example, HEVC or VVC, into the bitstream. In addition, the sequence of texture frames is coded with a video coder.

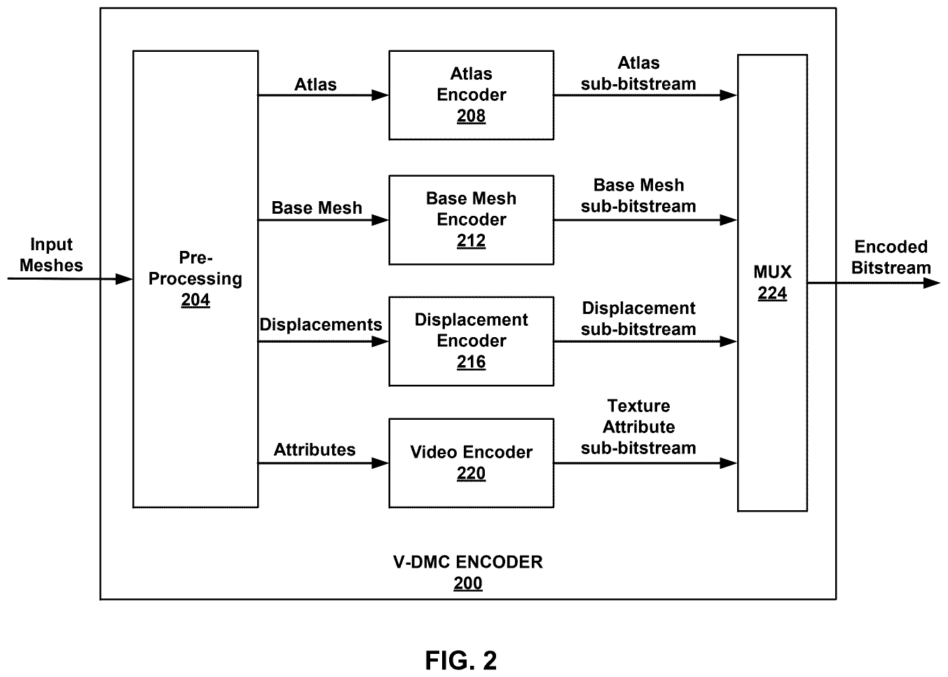

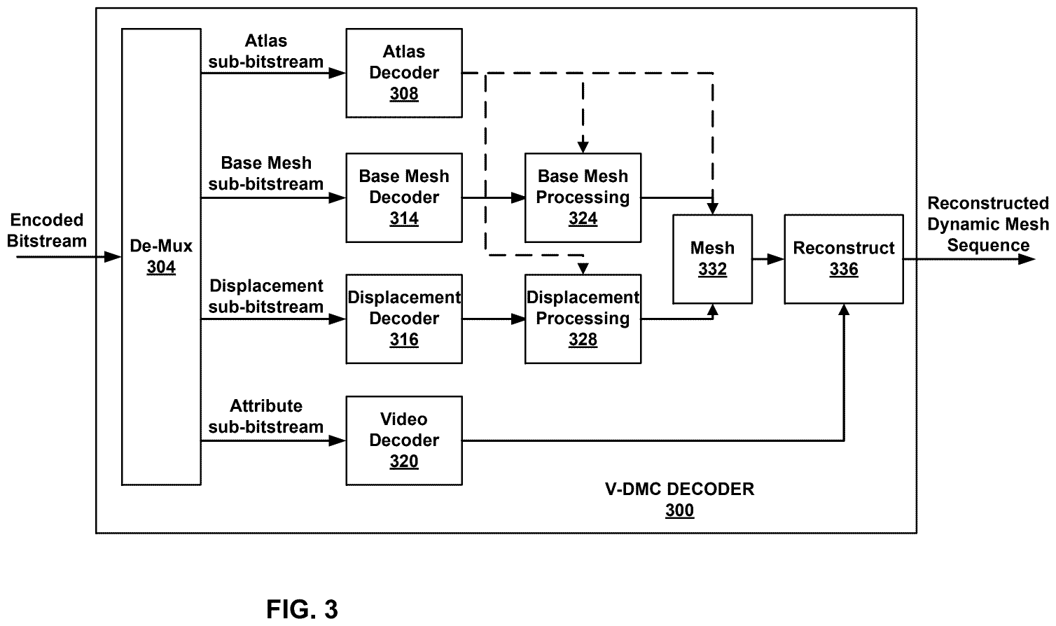

FIGS. 2 and 3 show the overall system model for the current V-DMC test model (TM) encoder (V-DM encoder 200 in FIG. 2) and decoder (V-DMC decoder 300 in FIG. 3) architecture. V-DMC encoder 200 performs volumetric media conversion, and V-DMC decoder 300 performs a corresponding reconstruction. The 3D media is converted to a series of sub-bitstreams: base mesh, displacement, and texture attributes. Additional atlas information is also included in the bitstream to enable inverse reconstruction, as described in N00680.

FIG. 2 shows an example implementation of V-DMC encoder 200. In the example of FIG. 2, V-DMC encoder 200 includes pre-processing unit 204, atlas encoder 208, base mesh encoder 212, displacement encoder 216, and video encoder 220. Pre-processing unit 204 receives an input mesh sequence and generates a base mesh, the displacement vectors, and the texture attribute maps. Base mesh encoder 212 encodes the base mesh. Displacement encoder 216 encodes the displacement vectors, for example as V3C video components or using arithmetic displacement coding. Video encoder 220 encodes the texture attribute components, e.g., texture or material information, using any video codec, such as the High Efficiency Video Coding (HEVC) Standard or the Versatile Video Coding (VVC) standard.

Aspects of V-DMC encoder 200 will now be described in more detail. Pre-processing unit 204 represents the 3D volumetric data as a set of base meshes and corresponding refinement components. This is achieved through a conversion of input dynamic mesh representations into a number of V3C components: a base mesh, a set of displacements, a 2D representation of the texture map, and an atlas. The base mesh component is a simplified low-resolution approximation of the original mesh in the lossy compression and is the original mesh in the lossless compression. The base mesh component can be encoded by base mesh encoder 212 using any mesh codec.

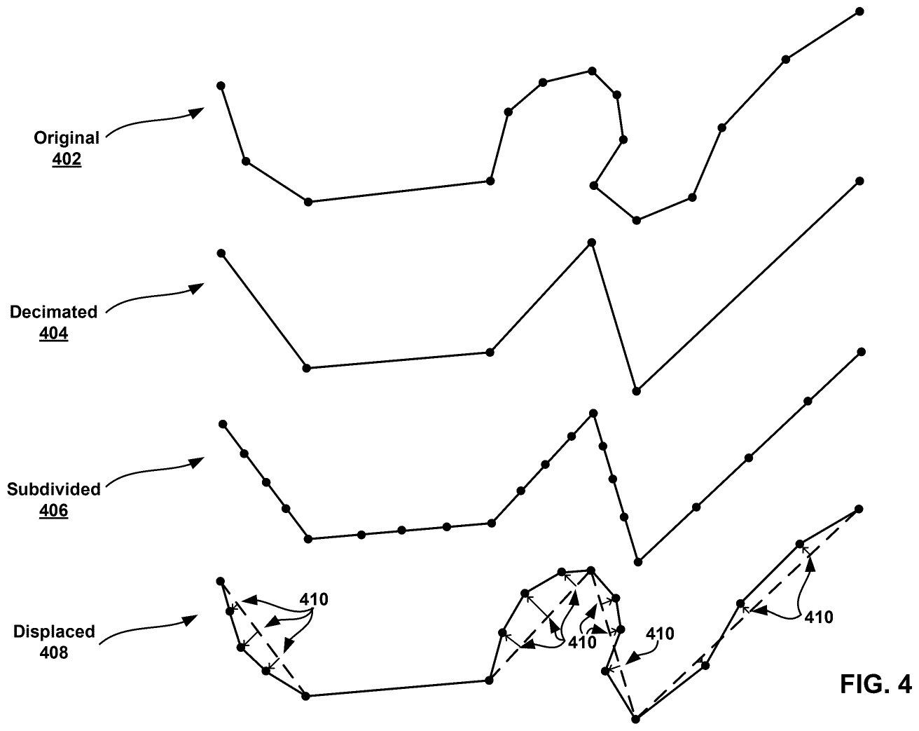

Base mesh encoder 212 is represented as Static Mesh Encoder in FIG. 4 and employs an implementation of the Edgebreaker algorithm, e.g., m63344, for encoding the base mesh where the connectivity is encoded using a CLERS op code, e.g., from Rossignac and Lopes, and the residual of the attribute is encoded using prediction from the previously encoded/decoded vertices' attributes.

Aspects of base mesh encoder 212 will now be described in more detail. One or more submeshes are input to base mesh encoder 212. Submeshes are generated by pre-processing unit 204. Submeshes are generated from original meshes by utilizing semantic segmentation. Each base mesh may include of one or more submeshes.

Base mesh encoder 212 may process connected components. Connected components include a cluster of triangles that are connected by their neighbors. A submesh can have one or more connected components. Base mesh encoder 212 may encode one “connected component” at a time for connectivity and attributes encoding and then performs entropy encoding on all “connected components”.

Base mesh encoder 212 defines and categorizes the input basemesh into the connectivity and attributes. The geometry and texture coordinates (UV coordinates) are categorized as attributes.

Multiplexer 224 combines the atlas sub-bitstream, base mesh sub-bitstream, displacement sub-bitstream, and texture attribute sub-bitstream into a combined encoded bitstream.

FIG. 3 shows an example implementation of V-DMC decoder 300. In the example of FIG. 3, V-DMC decoder 300 includes demultiplexer 304, atlas decoder 308, base mesh decoder 314, displacement decoder 316, video decoder 320, base mesh processing unit 324, displacement processing unit 328, mesh generation unit 332, and reconstruction unit 336.

Demultiplexer 304 separates the encoded bitstream into an atlas sub-bitstream, a base-mesh sub-bitstream, a displacement sub-bitstream, and a texture attribute sub-bitstream. Atlas decoder 308 decodes the atlas sub-bitstream to determine the atlas information to enable inverse reconstruction. Base mesh decoder 314 decodes the base mesh sub-bitstream, and base mesh processing unit 324 reconstructs the base mesh. Displacement decoder 316 decodes the displacement sub-bitstream, and displacement processing unit 328 reconstructs the displacement vectors. Mesh generation unit 332 modifies the base mesh based on the displacement vector to form a displaced mesh.

Video decoder 320 decodes the texture attribute sub-bitstream to determine the texture attribute map, and reconstruction unit 336 associates the texture attributes with the displaced mesh to form a reconstructed dynamic mesh.

A detailed description of the proposal that was selected as the starting point for the V-DMC standardization can be found in m59281. The following description will detail the displacement vector coding in the current V-DMC test model and WD 2.0 of V-DMC, ISO/IEC JTC1/SC29/WG7, N00546, January 2023 (hereinafter “WD 2.0”).

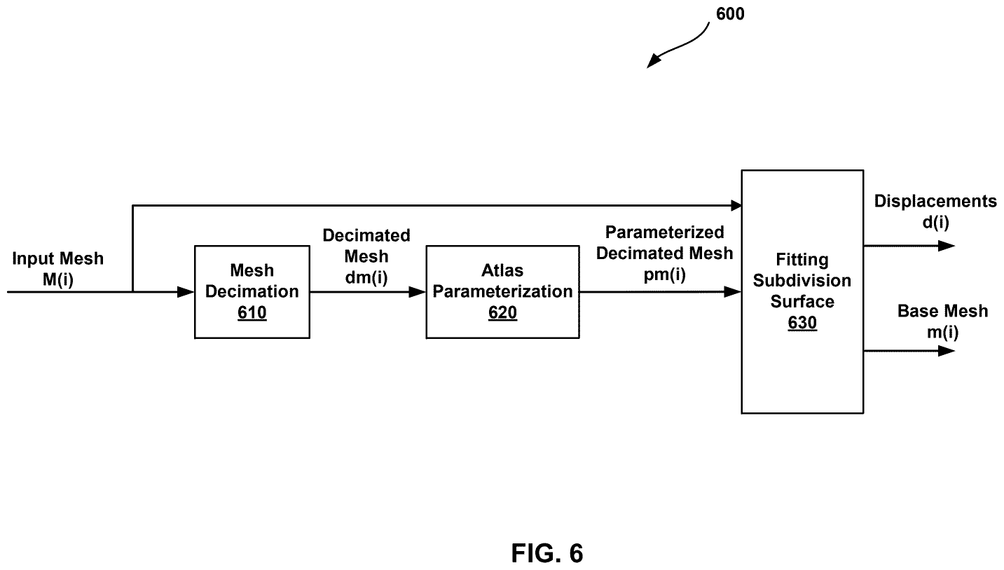

A pre-processing system, such as pre-processing system 600 described with respect to FIG. 6, may be configured to perform preprocessing on an input mesh M(i). FIG. 4 illustrates the basic idea behind the proposed pre-processing scheme using a 2D curve. The same concepts may be applied to the input 3D mesh M(i) to produce a base mesh m(i) and a displacement field d(i).

In FIG. 4, the input 2D curve (represented by a 2D polyline), referred to as original curve 402, is first downsampled to generate a base curve/polyline, referred to as the decimated curve 404. A subdivision scheme, such as that described in Garland et al, Surface Simplification Using Quadric Error Metrics (https://www.cs.cmu.edu/˜garland/Papers/quadrics.pdf), is then applied to the decimated polyline to generate a subdivided curve 406. For instance, in FIG. 4, a subdivision scheme using an iterative interpolation scheme is applied. The scheme includes inserting at each iteration a new point in the middle of each edge of the polyline. In the example illustrated, two subdivision iterations were applied.

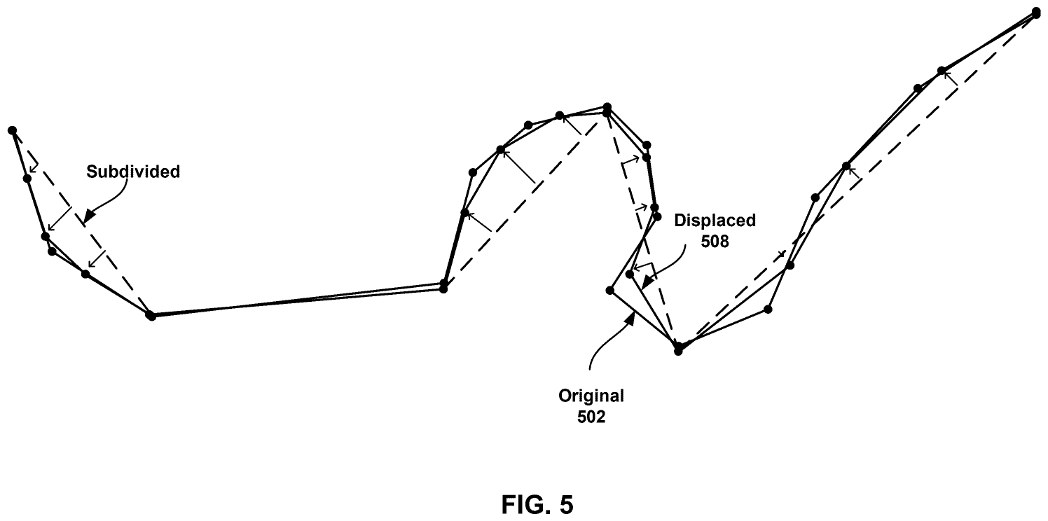

The proposed scheme is independent of the chosen subdivision scheme and may be combined with other subdivision schemes. The subdivided polyline is then deformed, or displaced, to get a better approximation of the original curve. This better approximation is displaced curve 408 in FIG. 4. Displacement vectors (arrows 410 in FIG. 4) are computed for each vertex of the subdivided mesh such that the shape of the displaced curve is as close as possible to the shape of the original curve (see FIG. 5). As illustrated by portion 508 of displaced curve 408 and portion 502 of original curve 402, for example, the displaced curve may not perfectly match the original curve.

An advantage of the subdivided curve is that the subdivision structure allows fir efficient compression, while still offering a faithful approximation of the original curve. The compression efficiency is obtained thanks to the following properties:
The decimated/base curve has a low number of vertices and requires a limited number of bits to be encoded/transmitted.
The subdivided curve is automatically generated by the decoder once the base/decimated curve is decoded (i.e., no need for any information other than the subdivision scheme type and subdivision iteration count).
The displaced curve is generated by decoding the displacement vectors associated with the subdivided curve vertices. Besides allowing for spatial/quality scalability, the subdivision structure enables efficient transforms such as wavelet decomposition, which can offer high compression performance.

FIG. 6 shows a block diagram of pre-processing system 600 which may be included in V-DMC encoder 200 or may be separate from V-DMC encoder 200. Pre-processing system 600 represents an example implementation of pre-processing unit 204 as described with respect to FIG. 2. In the example of FIG. 6, pre-processing system 600 includes mesh decimation unit 610, atlas parameterization unit 620, and subdivision surface fitting unit 630.

Mesh decimation unit 610 uses a simplification technique to decimate the input mesh M(i) and produce the decimated mesh dm(i). The decimated mesh dm(i) is then re-parameterized by atlas parameterization unit 620, which may for example use the UVAtlas tool. The generated mesh is denoted as pm(i). The UVAtlas tool considers only the geometry information of the decimated mesh dm(i) when computing the atlas parameterization, which is likely sub-optimal for compression purposes. Better parameterization schemes or tools may also be considered with the proposed framework.

Applying re-parameterization to the input mesh makes it possible to generate a lower number of patches. This reduces parameterization discontinuities and may lead to better RD performance. Subdivision surface fitting unit 630 takes as input the re-parameterized mesh pm(i) and the input mesh M(i) and produces the base mesh m(i) together with a set of displacements d(i). First, pm(i) is subdivided by applying the subdivision scheme. The displacement field d(i) is computed by determining for each vertex of the subdivided mesh the nearest point on the surface of the original mesh M(i).

For the Random Access (RA) condition, a temporally consistent re-meshing may be computed by considering the base mesh m(j) of a reference frame with index j as the input for subdivision surface fitting unit 630. This makes it possible to produce the same subdivision structure for the current mesh M′(i) as the one computed for the reference mesh M′(j). Such a re-meshing process makes it possible to skip the encoding of the base mesh m(i) and re-use the base mesh m(j) associated with the reference frame M(j). This may also enable better temporal prediction for both the attribute and geometry information. More precisely, a motion field f(i) describing how to move the vertices of m(j) to match the positions of m(i) is computed and encoded. Note that such time-consistent re-meshing is not always possible. The proposed system compares the distortion obtained with and without the temporal consistency constraint and chooses the mode that offers the best RD compromise.

Note that the pre-processing system is not normative and may be replaced by any other system that produces displaced subdivision surfaces. A possible efficient implementation would constrain the 3D reconstruction unit to directly generate displaced subdivision surface and avoids the need for such pre-processing.

V-DMC encoder 200 and V-DMC decoder 300 may be configured to perform displacements coding. Depending on the application and the targeted bitrate/visual quality, the encoder may optionally encode a set of displacement vectors associated with the subdivided mesh vertices, referred to as the displacement field d(i), as described in this section.

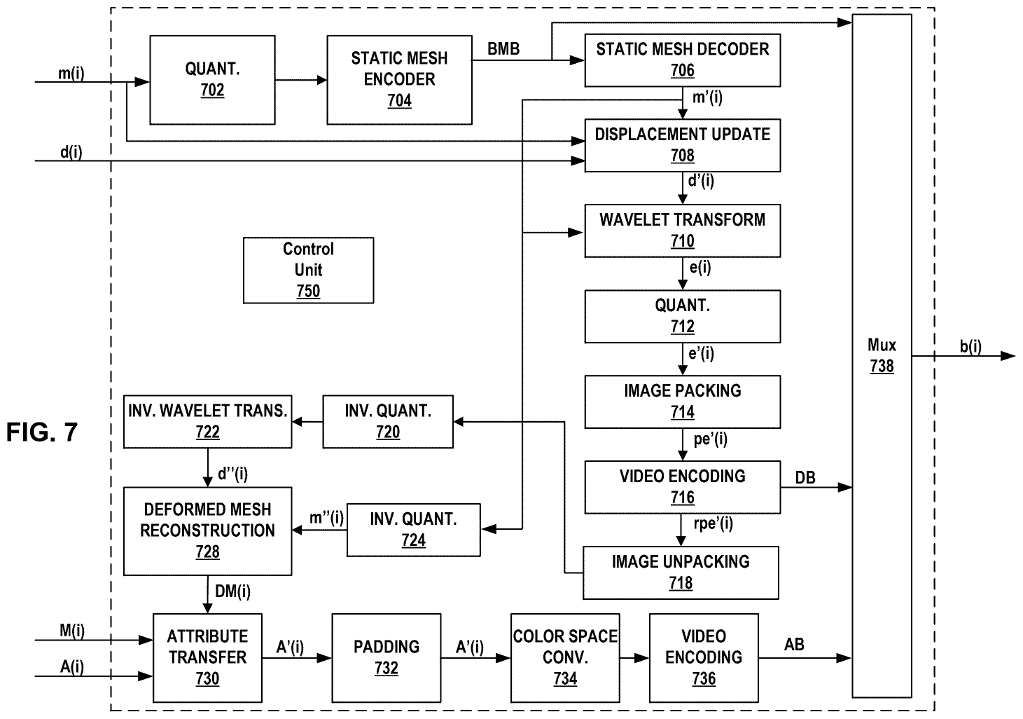

FIG. 7 shows V-DMC encoder 700, which is configure to implement an intra encoding process. V-DMC encoder 700 represents an example implementation of V-DMC encoder 200.

FIG. 7 includes the following abbreviations:
m(i)—Base mesh
d(i)—Displacements
m″(i)—Reconstructed Base Mesh
d″(i)—Reconstructed Displacements
A(i)—Attribute Map
A′(i)—Updated Attribute Map
M(i)—Static/Dynamic Mesh
DM(i)—Reconstructed Deformed Mesh
m′(i)—Reconstructed Quantized Base Mesh
d′(i)—Updated Displacements
e(i)—Wavelet Coefficients
e′(i)—Quantized Wavelet Coefficients
pe′(i)—Packed Quantized Wavelet Coefficients
rpe′(i)—Reconstructed Packed Quantized Wavelet Coefficients
AB—Compressed attribute bitstream
DB—Compressed displacement bitstream
BMB—Compressed base mesh bitstream

V-DMC encoder 200 receives base mesh m(i) and displacements d(i), for example from pre-processing system 600 of FIG. 6. V-DMC encoder 200 also retrieves mesh M(i) and attribute map A(i).

Quantization unit 702 quantizes the base mesh, and static mesh encoder 704 encodes the quantized based mesh to generate a compressed base mesh bitstream.

Static mesh decoder 706 then decodes the compressed base mesh bitstream to determine the reconstructed quantized base mesh m′(i). Displacement update unit 708 uses the reconstructed quantized base mesh m′(i) to update the displacement field d(i) to generate an updated displacement field d′(i). This process considers the differences between the reconstructed base mesh m′(i) and the original base mesh m(i). By exploiting the subdivision surface mesh structure, wavelet transform unit 710 applies a wavelet transform to d′(i) to generate a set of wavelet coefficients. The scheme is agnostic of the transform applied and may leverage any other transform, including the identity transform. Quantization unit 712 quantizes wavelet coefficients, and image packing unit 714 packs the quantized wavelet coefficients into a 2D image/video that can be compressed using a traditional image/video encoder in the same spirit as V-PCC to generate a displacement bitstream.

Attribute transfer unit 730 converts the original attribute map A(i) to an updated attribute map that corresponds to the reconstructed deformed mesh DM(i). Padding unit 732 pads the updated attributed map by, for example, filling patches of the frame that have empty samples with interpolated samples that may improve coding efficiency and reduce artifacts. Color space conversion unit 734 converts the attribute map into a different color space, and video encoding unit 736 encodes the updated attribute map in the new color space, using for example a video codec, to generate an attribute bitstream.

Multiplexer 738 combines the compressed attribute bitstream, compressed displacement bitstream, and compressed base mesh bitstream into a single compressed bitstream.

Image unpacking unit 718 and inverse quantization unit 720 apply image unpacking and inverse quantization to the reconstructed packed quantized wavelet coefficients generated by video encoding unit 716 to obtain the reconstructed version of the wavelet coefficients. Inverse wavelet transform unit 722 applies and inverse wavelet transform to the reconstructed wavelet coefficient to determine reconstructed displacements d″(i).

Inverse quantization unit 724 applies an inverse quantization to the reconstructed quantized base mesh m′(i) to obtain a reconstructed base mesh m″(i). Deformed mesh reconstruction unit 728 subdivides m″(i) and applies the reconstructed displacements d″(i) to its vertices to obtain the reconstructed deformed mesh DM(i).

Image unpacking unit 718, inverse quantization unit 720, inverse wavelet transform unit 722, and deformed mesh reconstruction unit 728 represent a displacement decoding loop. Inverse quantization unit 724 and deformed mesh reconstruction unit 728 represent a base mesh decoding loop. V-DMC encoder 700 includes the displacement decoding loop and the base mesh decoding loop so that V-DMC encoder 700 can make encoding decisions, such as determining an acceptable rate-distortion tradeoff, based on the same decoded mesh that a mesh decoder will generate, which may include distortion due to the quantization and transforms. V-DMC encoder 700 may also use decoded versions of the base mesh, reconstructed mesh, and displacements for encoding subsequent base meshes and displacements.

Control unit 750 generally represents the decision making functionality of V-DMC encoder 700. During an encoding process, control unit 750 may, for example, make determinations with respect to mode selection, rate allocation, quality control, and other such decisions.

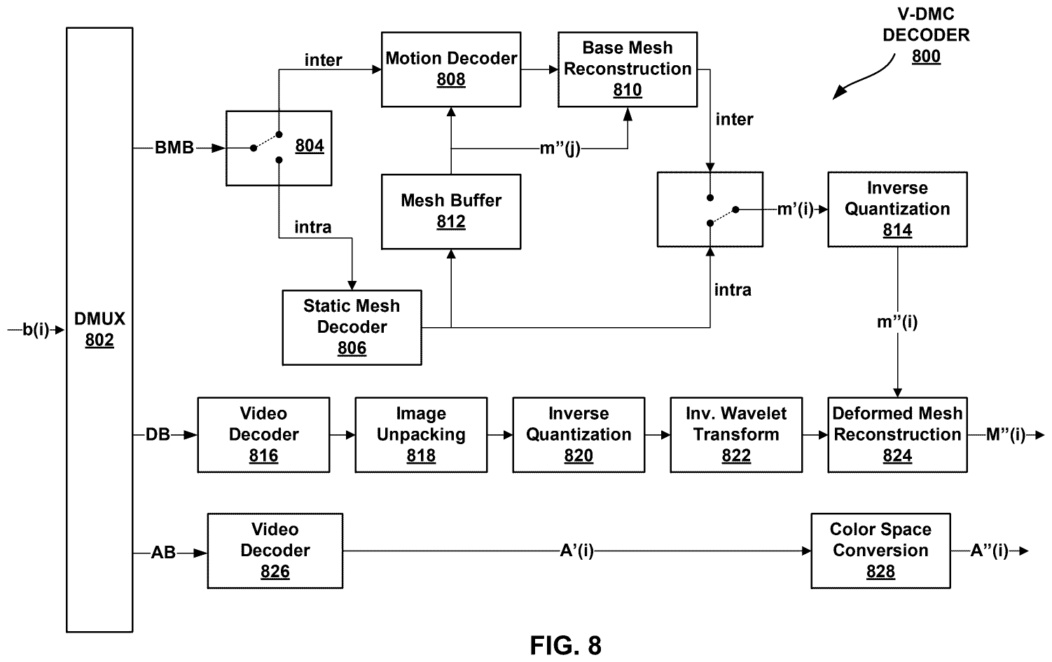

FIG. 8 shows V-DMC decoder 800, which may be configured to perform either intra- or inter-decoding. V-DMC decoder 800 represents an example implementation of V-DMC decoder 300. The processes described with respect to FIG. 8 may also be performed, in full or in part, by V-DMC encoder 200.

V-DMC decoder 800 includes demultiplexer (DMUX) 802, which receives compressed bitstream b(i) and separates the compressed bitstream into a base mesh bitstream (BMB), a displacement bitstream (DB), and an attribute bitstream (AB). Mode select unit 804 determines if the base mesh data is encoded in an intra mode or an inter mode. If the base mesh is encoded in an intra mode, then static mesh decoder 806 decodes the mesh data without reliance on any previously decoded meshes. If the base mesh is encoded in an inter mode, then motion decoder 808 decodes motion, and base mesh reconstruction unit 810 applies the motion to an already decoded mesh (m″(j)) stored in mesh buffer 812 to determine a reconstructed quantized base mesh (m′(i))). Inverse quantization unit 814 applies an inverse quantization to the reconstructed quantized base mesh to determine a reconstructed base mesh (m″(i)).

Video decoder 816 decodes the displacement bitstream to determine a set or frame of quantized transform coefficients. Image unpacking unit 818 unpacks the quantized transform coefficients. For example, video decoder 816 may decode the quantized transform coefficients into a frame, where the quantized transform coefficients are organized into blocks with particular scanning orders. Image unpacking unit 818 converts the quantized transform coefficients from being organized in the frame into an ordered series. In some implementations, the quantized transform coefficients may be directly coded, using a context-based arithmetic coder for example, and unpacking may be unnecessary.

Regardless of whether the quantized transform coefficients are decoded directly or in a frame, inverse quantization unit 820 inverse quantizes, e.g., inverse scales, quantized transform coefficients to determine de-quantized transform coefficients. Inverse wavelet transform unit 822 applies an inverse transform to the de-quantized transform coefficients to determine a set of displacement vectors. Deformed mesh reconstruction unit 824 deforms the reconstructed base mesh using the decoded displacement vectors to determine a decoded mesh (M″(i)).

Video decoder 826 decodes the attribute bitstream to determine decoded attribute values (A′(i)), and color space conversion unit 828 converts the decoded attribute values into a desired color space to determine final attribute values (A″(i)). The final attribute values correspond to attributes, such as color or texture, for the vertices of the decoded mesh.

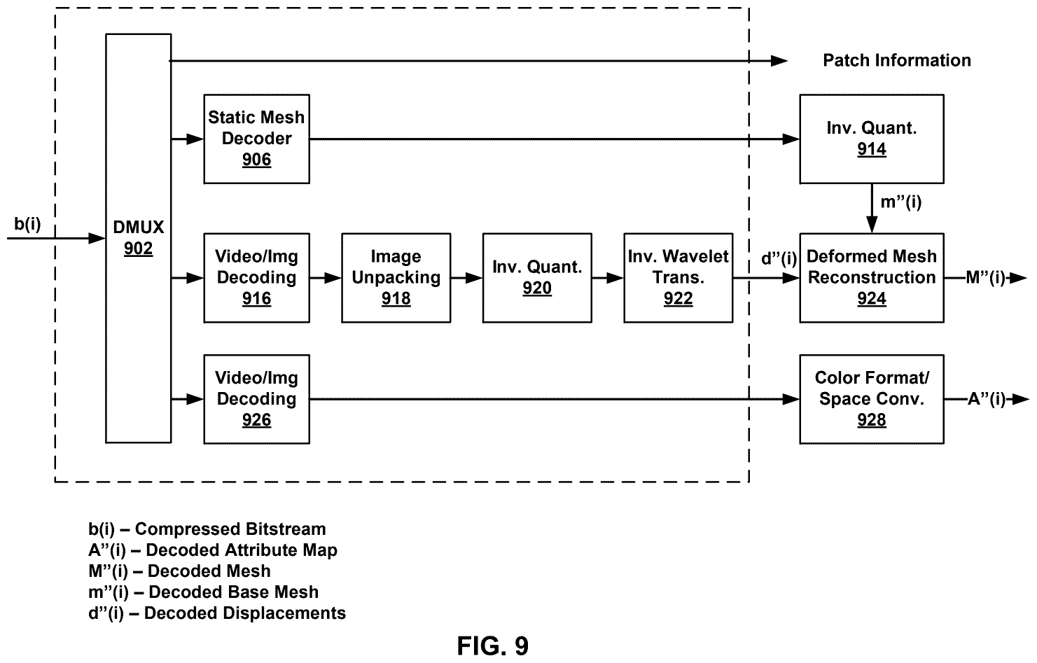

FIG. 9 shows a block diagram of an intra decoder which may, for example, be part of V-DMC decoder 300. De-multiplexer (DMUX) 902 separates compressed bitstream (bi) into a mesh sub-stream, a displacement sub-stream for positions and potentially for each vertex attribute, zero or more attribute map sub-streams, and an atlas sub-stream containing patch information in the same manner as in V3C/V-PCC.

De-multiplexer 902 feeds the mesh sub-stream to static mesh decoder 906 to generate the reconstructed quantized base mesh m′(i). Inverse quantization unit 914 inverse quantizes the base mesh to determine the decoded base mesh m″(i). Video/image decoding unit 916 decodes the displacement sub-stream, and image unpacking unit 918 unpacks the image/video to determine quantized transform coefficients, e.g., wavelet coefficients. Inverse quantization unit 920 inverse quantizes the quantized transform coefficients to determine dequantized transform coefficients. Inverse transform unit 922 generates the decoded displacement field d″(i) by applying the inverse transform to the unquantized coefficients. Deformed mesh reconstruction unit 924 generates the final decoded mesh (M″(i)) by applying the reconstruction process to the decoded base mesh m″(i) and by adding the decoded displacement field d″(i). The attribute sub-stream is directly decoded by video/image decoding unit 926 to generate an attribute map A″(i). Color format/space conversion unit 928 may convert the attribute map into a different format or color space.

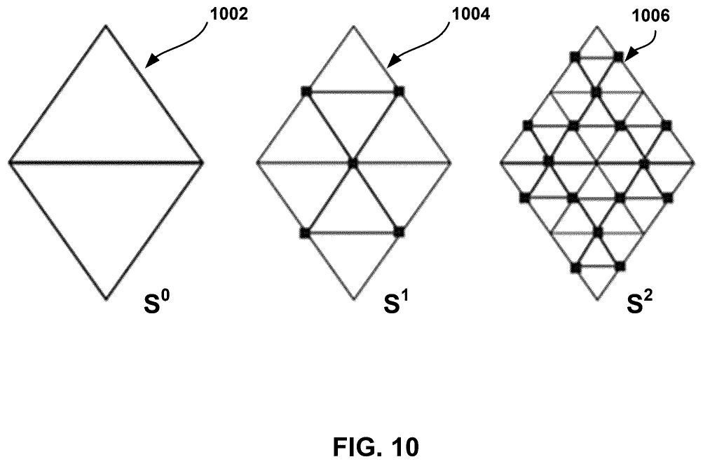

V-DMC encoder 200 and V-DMC decoder 300 may use various subdivision schemes. A possible solution is the mid-point subdivision scheme, which at each subdivision iteration subdivides each triangle into 4 sub-triangles as shown in FIG. 10. New vertices are introduced in the middle of each edge. In the example, FIG. 10, triangles 1002 are subdivided to obtain triangles 1004, and triangles 1004 are subdivided to obtain triangles 1006. The subdivision process is applied independently to the geometry and to the texture coordinates since the connectivity for the geometry and for the texture coordinates is usually different. The sub-division scheme computes the position Pos(v₁₂) of a newly introduced vertex v₁₂ at the center of an edge (v₁, v₂), as follows:

$$Pos ( {v}_{12} ) = \frac{1}{2} ( Pos ( {v}_{1} ) + Pos ( {v}_{2} ) ) ,$$

where Pos(v₁) and Pos(v₂) are the positions of the vertices v₁ and v₂.

The same process is used to compute the texture coordinates of the newly created vertex. For normal vectors, an extra normalization step is applied as follows:

$$N ( {v}_{12} ) = \frac{N ( {v}_{1} ) + N ( {v}_{2} )}{‖ N ( {v}_{1} ) + N ( {v}_{2} ) ‖} ,$$

here:
N(v₁₂), N(v₁), and N(v₂) are the normal vectors associated with the vertices v₁₂, v₁, and v₂, respectively.
∥x∥ is the norm2 of the vector x.

V-DMC encoder 200 and V-DMC decoder 300 may apply various wavelet transforms. The results reported for CfP are based on a linear wavelet transform.

The prediction process is defined as follows:

$$Signal ( v ) ← Signal ( v ) - \frac{1}{2} ( Signal ( {v}_{1} ) + Signal ( {v}_{2} ) )$$

where
v is the vertex introduced in the middle of the edge (v₁, v₂), and
Signal(v), Signal(v₁), and Signal(v₂) are the values of the geometry/vertex attribute signals at the vertices v, v₁, and v₂, respectively.

The update process is defined as follows:

$$Signal ( v ) ← Signal ( v ) - \frac{1}{8} {\sum }_{w ∈ {v}^{*}} Signal ( w )$$

where v* is the set of neighboring vertices of the vertex v.

Note that the scheme allows to skip the update process. The wavelet coefficients could be quantized e.g., by using a uniform quantizer with a dead zone.

Local vs. canonical coordinate systems for displacements will now be explained. The displacement field d(i) is defined in the same cartesian coordinate system as the input mesh. A possible optimization is to transform d(i) from this canonical coordinate system to a local coordinate system, which is defined by the normal to the subdivided mesh at each vertex.

The advantage of considering a local coordinate system for the displacements is the possibility to quantize more heavily the tangential components of the displacements compared to the normal component. In fact, the normal component of the displacement has more significant impact on the reconstructed mesh quality than the two tangential components.

V-DMC encoder 200 and V-DMC decoder 300 may be configured to packing wavelet coefficients. For example, V-DMC encoder 200 and V-DMC decoder 300 may use the following scheme to pack the wavelet coefficients into a 2D image.
Traverse the coefficients from low to high frequency.
For each coefficient, determine the index of the N×M pixel block (e.g., N=M=16) in which it should be stored following a raster order for blocks.
The position within the N×M pixel block is computed by using a Morton order to maximize locality.

Other packing schemes may also be used (e.g., zigzag order, raster order). The encoder could explicitly signal in the bitstream the used packing scheme (e.g., atlas sequence parameters). This could be done at patch, patch group, tile, or sequence level.

V-DMC encoder 200 and V-DMC decoder 300 may perform displacement video encoding and decoding, respectively. The proposed scheme is agnostic of which video coding technology is used. When coding the displacement wavelet coefficients, a lossless approach may be used since the quantization is applied in a separate module. Another approach is to rely on the video encoder to compress the coefficients in a lossy manner and apply a quantization either in the original or transform domain.

Aspects of WD 2.0 will now be described.

### Lifting Transform Parameter Set and Semantics

| | Descriptor |
|---|---|
| vmc_lifting_transform_parameters( index, ltpIndex ){ | |
| vmc_transform_lifting_skip_update_flag[index][ ltpIndex ] | u(1) |
| vmc_transform_lifting_quantization_parameters_x[index][ ltpIndex ] | u(6) |
| vmc_transform_lifting_quantization_parameters_y[index][ ltpIndex ] | u(6) |
| vmc_transform_lifting_quantization_parameters_z[index][ ltpIndex ] | u(6) |
| vmc_transform_log2_lifting_lod_inverse_scale_x[index][ ltpIndex ] | ue(v) |
| vmc_transform_log2_lifting_lod_inverse_scale_y[index][ ltpIndex ] | ue(v) |
| vmc_transform_log2_lifting_lod_inverse_scale_z[index][ ltpIndex ] | ue(v) |
| vmc_transform_log2_lifting_update_weight[index][ ltpIndex ] | ue(v) |
| vmc_transform_log2_lifting_prediction_weight[index][ ltpIndex ] | ue(v) |
| } | |

syntax_element[i][ltpIndex] with i equal to 0 may be applied to the displacement. syntax_element[i][ltpIndex] with i equal to non-zero may be applied to the (i−1)-th attribute, where ltpIndex is the index of the lifting transform parameter set list.

vmc_transform_lifting_skip_update_flag[i][ltpIndex] equal to 1 indicates the step of the lifting transform applied to the displacement is skipped in the vmc_lifting_transform_parameters(index, lptIndex) syntax structure, where ltpIndex is the index of the lifting transform parameter set list. vmc_transform_lifting_skip_update_flag[i][ltpIndex] with i equal to 0 may be applied to the displacement. vmc_transform_lifting_skip_update_flag[i][ltpIndex] with i equal to non-zero may be applied to the (i−1)-th attribute.

vmc_transform_lifting_quantization_parameters_x[i][ltpIndex] indicates the quantization parameter to be used for the inverse quantization of the x-component of the displacements wavelets coefficients. The value of vmc_transform_lifting_quantization_parameters_x[index][ltpIndex] shall be in the range of 0 to 51, inclusive.

vmc_transform_lifting_quantization_parameters_y[i][ltpIndex] indicates the quantization parameter to be used for the inverse quantization of the y-component of the displacements wavelets coefficients. The value of vme_transform_lifting_quantization_parameters_x[index][ltpIndex] shall be in the range of 0 to 51, inclusive.

vmc_transform_lifting_quantization_parameters_z[i][ltpIndex] indicates the quantization parameter to be used for the inverse quantization of the z-component of the displacements wavelets coefficients. The value of vmc_transform_lifting_quantization_parameters_x[index][ltpIndex] shall be in the range of 0 to 51, inclusive.

vmc_transform_log2_lifting_lod_inverse_scale_x[i][ltpIndex] indicates the scaling factor applied to the x-component of the displacements wavelets coefficients for each level of detail.

vmc_transform_log2_lifting_lod_inverse_scale_y[i][ltpIndex] indicates the scaling factor applied to the y-component of the displacements wavelets coefficients for each level of detail.

vmc_transform_log2_lifting_lod_inverse_scale_z[i][ltpIndex] indicates the scaling factor applied to the z-component of the displacements wavelets coefficients for each level of detail.

vmc_transform_log2_lifting_update_weight[i][ltpIndex] indicates the weighting coefficients used for the update filter of the wavelet transform.

vmc_transform_log2_lifting_prediction_weight[i][ltpIndex] the weighting coefficients used for the prediction filter of the wavelet transform.

V-DMC encoder 200 and V-DMC decoder 300 may perform inverse image packing of wavelet coefficients.

Inputs to this process are:
width, which is a variable indicating the width of the displacements video frame,
height, which is a variable indicating the height of the displacements video frame,
bitDepth, which is a variable indicating the bit depth of the displacements video frame,
dispQuantCoeffFrame, which is a 3D array of size width×height×3 indicating the packed quantized displacement wavelet coefficients.
blockSize, which is a variable indicating the size of the displacements coefficients blocks,
positionCount, which is a variable indicating the number of positions in the subdivided submesh.

The output of this process is dispQuantCoeffArray, which is a 2D array of size positionCount×3 indicating the quantized displacement wavelet coefficients.

Let the function extracOddBits(x) be defined as follows:

```
x = extracOddBits( x ) {
  x = x & 0x55555555
  x = (x |(x >> 1)) & 0x33333333
  x = (x |(x >> 2)) & 0x0F0F0F0F
  x = (x |(x >> 4)) & 0x00FF00FF
  x = (x |(x >> 8)) & 0x0000FFFF
}
```

Let the function computeMorton2D(i) be defined as follows:

```
(x, y) = computeMorton2D( i ) {
  x = extracOddBits( i >> 1 )
  y = extracOddBits( i )
}
```

The wavelet coefficients inverse packing process proceeds as follows:

```
pixelsPerBlock = blockSize * blockSize
widthInBlocks = width / blockSize
shift = (1 << bitDepth) >> 1
for( v = 0; v < positionCount; v++ ) {
  blockIndex = v / pixelsPerBlock
  indexWithinBlock = v % pixelsPerBlock
  x0 = (blockIndex % widthInBlocks) * blockSize
  y0 = (blockIndex / widthInBlocks) * blockSize
  ( x, y ) = computeMorton2D(indexWithinBlock)
  x = x0 + x
  y = y0 + y
  for( d = 0; d < 3; d++ ) {
    dispQuantCoeffArray[ v ][ d ] = dispQuantCoeffFrame[ x ][ y ][ d ] − shift
  }
}
```

V-DMC encoder 200 and V-DMC decoder 300 may perform inverse quantization of wavelet coefficients.

Inputs to this process are:
positionCount, which is a variable indicating the number of positions in the subdivided submesh.
dispQuantCoeffArray, which is a 2D array of size positionCount×3 indicating the quantized displacement wavelet coefficients.
subdivisionIterationCount, which is a variable indicating the number of subdivision iterations.
liftingQP, which is a 1D array of size 3 indicating the quantization parameter associated with the three displacement dimensions.
liftingLevelOfDetailInverseScale, which is a 1D array of size 3 indicating the inverse scale factor associated with the three displacement dimensions
levelOfDetailAttributeCounts, a 1D array of size (subdivisionIterationCount+1) indicating the number of attributes associated with each subdivision iteration.
bitDepthPosition, which is a variable indicating the bit depth of the mesh positions.

The output of this process is dispCoeffArray, which is a 2D array of size positionCount×3 indicating the dequantized displacement wavelet coefficients.

The wavelet coefficients inverse quantization process proceeds as follows:

```
for ( d =0; d < 3; ++d) {
  qp = liftingQP[ d ]
  iscale[ d ] = qp >= 0 ? pow( 0.5, 16 − bitDepthPosition + ( 4 − qp ) / 6) : 0.0
  ilodScale[ d ] = liftingLevelOfDetailInverseScale[ d ]
}
vcount0 = 0
for( i = 0; i < subdivisionIterationCount; i++ ) {
  vcount1 = levelOfDetailAttributeCounts[ i ]
  for( v = vcount0; v < vcount1; v++ ) {
    for( d = 0; d < 3; d++ ) {
      dispCoeffArray[ v ][ d ] = dispQuantCoeffArray[ v ][ d ] * iscale[ k ]
    }
  }
  vcount0 = vcount1
  for( d = 0; d < 3; d++ ) {
    iscale[d] *= ilodScale[ d ]
  }
}
```

V-DMC encoder 200 and V-DMC decoder 300 may perform an inverse linear wavelet transform.

Inputs to this process are:
positionCount, which is a variable indicating the number of positions in the subdivided submesh.
dispCoeffArray, which is a 2D array of size positionCount×3 indicating the displacement wavelet coefficients.
levelOfDetailAttributeCounts, a 1D array of size (subdivisionIterationCount+1) indicating the number of attributes associated with each subdivision iteration.
edges, which is a 2D array of size positionCount×2 which indicates for each vertex v produced by the subdivision process described above the two indices (a, b) of the two vertices used to generate it (i.e., v generated as the middle of the edge (a, b)).
updateWeight, which is a variable indicating the lifting update weight.
predWeight, which is a variable indicating the lifting prediction weight.
skipUpdate, which is a variable indicating whether the update operation should be skipped (when 1) or not (when 0).

The output of this process is dispArray, which is a 2D array of size positionCount×3 indicating the displacements to be applied to the mesh positions.

The inverse wavelet transform process proceeds as follows:

```
for( i = 0; i < subdivisionIterationCount; i++ ) {
  vcount0 = levelOfDetailAttributeCounts[i]
  vcount1 = levelOfDetailAttributeCounts[i + 1]
  for ( v = vcount0; skipUpdate == 0 && v < vcount1; ++v ) {
    a = edges[v][0]
    b = edges[v][1]
    for( d = 0; d < 3; d++ ) {
      disp = updateWeight * dispCoeffArray[v][d]
      signal[a][d] −= disp
      signal[b][d] −= disp
    }
  }
  for ( v = vcount0; skipUpdate == 0 && v < vcount1; ++v ) {
    a = edges[v][0]
    b = edges[v][1]
    for( d = 0; d < 3; d++ ) {
      dispCoeffArray[v][d] +=
        predWeight * (dispCoeffArray[a][d] +
dispCoeffArray[b][d])
    }
  }
}
for ( v = 0; v < positionCount; ++v ) {
  for( d = 0; d < 3; d++ ) {
    dispArray[v][d] = dispCoeffArray[v][d]
  }
}
```

V-DMC encoder 200 and V-DMC decoder 300 may perform position displacement.

The inputs of this process are:
positionCount, which is a variable indicating the number of positions in the subdivided submesh.
positionsSubdiv, which is a 2D array of size positionCount×3 indicating the positions of the subdivided submesh.
dispArray, which is a 2D array of size positionCount×3 indicating the displacements to be applied to the mesh positions.
normals, which is a 2D array of size positionCount×3 indicating the normals to be used when applying the displacements to the submesh positions.
tangents, which is a 2D array of size positionCount×3 indicating the tangents to be used when applying the displacements to the submesh positions.
bitangents, which is a 2D array of size positionCount×3 indicating the tangents to be used when applying the displacements to the submesh positions.

The output of this process is positionsDisplaced, which is a 2D array of size positionCount×3 indicating the positions of the displaced subdivided submesh.

The positions displacement process proceeds as follows:

```
for ( v = 0; v < positionCount; ++v ) {
  for( d = 0; d < 3; d++ ) {
    positionsDisplaced[ v ][ d ] = positionsSubdiv[ v ][ d ] +
      dispArray[ v ][ 0 ] * normals[ v ][ d ] +
      dispArray[ v ][ 1 ] * tangents[ v ][ d ] +
      dispArray[ v ][ 2 ] * bitangents[ v ][ d ]
  }
```

This disclosure references the V-DMC CD specification text, “Text of ISO/IEC CD 23090-29 Video-based mesh coding”, ISO/IEC JTCT/SC29 WG07 output document N00885, Rennes, April 2024 (hereinafter “N00885”), and its software test model TMM 8.0, “V-DMC TMM 8.0,” ISO/IEC JTCT/SC29 WG07 output document N00874, Rennes, April 2024, both of which are incorporated herein by reference.

The following issues are observed in the vdmc_lifting_transform_parameters syntax (section 8.3.6.1.5):

| | Descriptor |
|---|---|
| vdmc_lifting_transform_parameters( ltpIndex, subdivisionCount ){ | |
| if( asve_lifting_offset_present_flag && ltpindex ==2 ) { | |
| vltp_lifting_main_param_flag[ ltpIndex ] | u(1) |
| for( i = 0; i < subdivisionCount [symbol] ; i++ ) { | |
| vltp_lifting_offset_values_num[ ltpIndex ][ i ] | se(v) |
| vltp_lifting_offset_values_deno_minus1[ ltpIndex ][ i ] | ue(v) |
| } | |
| } | |
| if( vltp_lifting_main_param_flag[ ltpIndex ] ) { | |
| vltp_skip_update_flag[ ltpIndex ] | u(1) |
| vltp_lod_lifting_parameter_flag[ ltpIndex ] | u(1) |
| for( i=0 ; i < subdivisionCount + 1; i++ ) { | |
| if( vltp_skip_update_flag[ ltpIndex ] ) | |
| UpdateWeight[ ltpIndex ][ i ] = 0 | |
| else { | |
| vltp_adaptive_update_weight_flag[ ltpIndex ][ i ] | u(1) |
| vltp_valence_update_flag[ ltpIndex ][ i ] | u(1) |
| if( vltp_lod_lifting_parameter_flag[ ltpIndex ] == 1 \|\| i == 0) { | |
| if( vltp_adaptive_update_weight_flag[ ltpIndex ][ i ] ) { | |
| vltp_lifting_update_weight_numerator[ ltpIndex ][ i ] | ue(v) |
| vltp_lifting_update_weight_denominator_minus1[ ltpIndex ][ i ] | ue(v) |
| UpdateWeight[ ltpIndex ][ i ] = | |
| ( vltp_lifting_update_weight_numerator[ ltpIndex ][ i ] ) ÷ | |
| ( vltp_lifting_update_weight_denominator_minus1[ ltpIndex ][ i ] + 1 ) | |
| if ( vltp_valence_update_flag[ ltpIndex ][ i ] ) { | |
| vltp_valence_update_weight[ ltpIndex ][ i ] | ue(v) |
| UpdateWeight[ ltpIndex ][ i ] *= 1 + | |
| (vltp_valence_update_weight[ ltpIndex ][ i ] * 0.1 ) | |
| } | |
| } else { | |
| if ( vltp_valence_update_flag[ ltpIndex ][ i ] ) { | |
| UpdateWeight[ ltpIndex ][ i ] = 1 + | |
| (vltp_valence_update_weight[ ltpIndex ][ i ] * 0.1 ) | |
| } | |
| vltp_log2_lifting_update_weight[ ltpIndex ][ i ] | ue(v) |
| UpdateWeight[ ltpIndex ][ i ] = | |
| 1 ÷ ( 1 << vltp_log2_lifting_update_weight[ ltpIndex ][ i ] ) | |
| } | |
| } else { | |
| UpdateWeight[ ltpIndex ][ i ] = UpdateWeight[ ltpIndex ][ 0 ] | |
| } | |
| } | |
| } | |
| vltp_log2_lifting_prediction_weight[ ltpIndex ] | ue(v) |
| PredictionWeight[ ltpIndex ] = 1 ÷ ( 1 << vltp_log2_lifting_prediction_weight[ ltpInde | |
| x ] ) | |
| } | |
| } | |

1. Syntax element vltp_lod_lifting_parameter_flag is signaled even when vltp_skip_update_flag is true.
2. Syntax elements vltp_adaptive_update_weight_flag and vltp_valence_update_flag are signaled per level of detail, which may not be necessary.
3. If the value of syntax element vltp_adaptive_update_weight_flag is equal to false, then the UpdateWeight is determined independently from the value of vltp_valence_update_flag.

This disclosure describes potential solutions for the issues explained above. The numbering below corresponds with the numbering above. Several of the proposed solutions may be combined.

Example #1—Syntax element vltp_lod_lifting_parameter_flag is signaled even when vltp_skip_update_flag is true.

This disclosure proposes moving the syntax element vltplod_lifting_parameter_flag to the else branch of the vltp_skip_update_flag condition, which means that vltp_lod_lifting_parameter_flag will only be signaled if vltp_skip_update_flag is equal to 0 (lifting update is skipped). The syntax element vltp_lod_lifting_parameter_flag would only be signaled for the first level of detail (if i==0).

Additionally, it can be checked whether the number of subdivision steps is greater than 0 (subdivisionCount>0). In this case, the syntax element vltp_lod_lfting_parameter_flag is only signaled if (i==0 and subdivisionCount>0). If vltp_lod_vlifting_parameter_flag is not present in the bitstream its value is unused (can be either equal to 0 or 1).

The following are proposed changes to the syntax, with additions shown between the delimiters <add> and </add> and deletions shown between the delimiters <del> and </del>:

| | Descriptor |
|---|---|
| vdmc_lifting_transform_parameters( ltpIndex, subdivisionCount ){ | |
| if( asve_lifting_offset_present_flag && ltpindex ==2 ) { | |
| vltp_lifting_main_param_flag[ ltpIndex ] | u(1) |
| for( i = 0; i < subdivisionCount [symbol] ; i++ ) { | |
| vltp_lifting_offset_values_num[ ltpIndex ][ i ] | se(v) |
| vltp_lifting_offset_values_deno_minus1[ ltpIndex ][ i ] | ue(v) |
| } | |
| } | |
| if( vltp_lifting_main_param_flag[ ltpIndex ] ) { | |
| vltp_skip_update_flag[ ltpIndex ] | u(1) |
| <del>vltp_lod_lifting_parameter_flag[ ltpIndex ] </del> | <del>u(1) |
| | </del> |
| for( i=0 ; i < subdivisionCount + 1; i++ ) { | |
| if( vltp_skip_update_flag[ ltpIndex ] ) | |
| UpdateWeight[ ltpIndex ][ i ] = 0 | |
| else { | |
| <add> if( i == 0 ) </add> | |
| <add> vltp_lod_lifting_parameter_flag[ ltpIndex ] </add> | <add> |
| | u(1) |
| | </add> |
| vltp_adaptive_update_weight_flag[ ltpIndex ][ i ] | u(1) |
| vltp_valence_update_flag[ ltpIndex ][ i ] | u(1) |
| if( vltp_lod_lifting_parameter_flag[ ltpIndex ] == 1 \|\| i == 0) { | |
| if( vltp_adaptive_update_weight_flag[ ltpIndex ][ i ] ) { | |
| vltp_lifting_update_weight_numerator[ ltpIndex ][ i ] | ue(v) |
| vltp_lifting_update_weight_denominator_minus1[ ltpIndex ][ i ] | ue(v) |
| UpdateWeight[ ltpIndex ][ i ] = | |
| ( vltp_lifting_update_weight_numerator[ ltpIndex ][ i ] ) ÷ | |
| ( vltp_lifting_update_weight_denominator_minus1[ ltpIndex ][ i ] + 1 ) | |
| .... | |
| } | |

The semantics are modified as follows:

vltp_lod_ifting_aiparameter_flag[ltpIndex] equal to 1 indicates the lifting transform parameters are signaled at LoD level. vltpvod_ifting_parameter_alag[ttppndex] equal to 0 indicates the lifting transform parameters applies across LoDs. ltpIndex is the index to lifting transform parameter set.

<add> If not present in the bitstream, then its value is equal to 0. </add>

Example #2—Syntax elements vltp_adaptive_update_weight_flag and vltp_valence_update_flag are signaled per level of detail, which may not be necessary.

It is proposed to signal the syntax elements vltp_adaptive_update_weight_flag and vltp_valence_update_flag only for the first level of detail (if i==0).

The following syntax changes are proposed:

| | Descriptor |
|---|---|
| vdmc_lifting_transform_parameters( ltpIndex, subdivisionCount ){ | |
| if( asve_lifting_offset_present_flag && ltpindex ==2 ) { | |
| vltp_lifting_main_param_flag[ ltpIndex ] | u(1) |
| for( i = 0; i < subdivisionCount [symbol] ; i++ ) { | |
| vltp_lifting_offset_values_num[ ltpIndex ][ i ] | se(v) |
| vltp_lifting_offset_values_deno_minus1[ ltpIndex ][ i ] | ue(v) |
| } | |
| } | |
| if( vltp_lifting_main_param_flag[ ltpIndex ] ) { | |
| vltp_skip_update_flag[ ltpIndex ] | u(1) |
| vltp_lod_lifting_parameter_flag[ ltpIndex ] | u(1) |
| for( i=0 ; i < subdivisionCount + 1; i++ ) { | |
| if( vltp_skip_update_flag[ ltpIndex ] ) | |
| UpdateWeight[ ltpIndex ][ i ] = 0 | |
| else { | |
| <add> if( i == 0 ) {</add> | |
| <add> vltp_adaptive_update_weight_flag[ ltpIndex ] [symbol] | <add> |
| </add> | u(1) |
| | </add> |
| <add> vltp_valence_update_flag[ ltpIndex ] [symbol] </add> | <add> |
| | u(1) |
| | </add> |
| <add> }</add> | |
| if( vltp_lod_lifting_parameter_flag[ ltpIndex ] == 1 \|\| i == 0) { | |
| if( vltp_adaptive_update_weight_flag[ ltpIndex ] <del> [ i ] | |
| </del> ) { | |
| vltp_lifting_update_weight_numerator[ ltpIndex ][ i ] | ue(v) |
| vltp_lifting_update_weight_denominator_minus1[ ltpIndex ][ i ] | ue(v) |
| UpdateWeight[ ltpIndex ][ i ] = | |
| ( vltp_lifting_update_weight_numerator[ ltpIndex ][ i ] ) ÷ | |
| ( vltp_lifting_update_weight_denominator_minus1[ ltpIndex ][ i ] + 1 ) | |
| if ( vltp_valence_update_flag[ ltpIndex ] <del> [ i ] | |
| </del>) { | |
| vltp_valence_update_weight[ ltpIndex ][ i ] | ue(v) |
| UpdateWeight[ ltpIndex ][ i ] *= 1 + | |
| (vltp_valence_update_weight[ ltpIndex ][ i ] * 0.1 ) | |
| } | |
| } else { | |
| if ( vltp_valence_update_flag[ ltpIndex ] <del> [ i ] | |
| </del>) { | |
| UpdateWeight[ ltpIndex ][ i ] = 1 + | |
| (vltp_valence_update_weight[ ltpIndex ][ i ] * 0.1 ) | |
| } | |
| vltp_log2_lifting_update_weight[ ltpIndex ][ i ] | ue(v) |
| UpdateWeight[ ltpIndex ][ i ] = | |
| 1 ÷ ( 1 << vltp_log2_lifting_update_weight[ ltpIndex ][ i ] ) | |
| } | |
| } else { | |
| UpdateWeight[ ltpIndex ][ i ] = UpdateWeight[ ltpIndex ][ 0 ] | |
| } | |
| } | |
| } | |
| vltp_log2_lifting_prediction_weight[ ltpIndex ] | ue(v) |
| PredictionWeight[ ltpIndex ] = 1 ÷ ( 1 << vltp_log2_lifting_prediction_weight[ ltpInde | |
| x ] ) | |
| } | |
| } | |

The semantics are modified as follows:

vltp_adaptive_update_weight_flag[ltpIndex]<del>[i]</del> equal to 1 indicates the update weight is represented as the ratio of numerator and denominator values. vltp_adaptive_update_weight_flag<del>[i]</del> equal to 0 indicates the update weight at i^{th} level of detail is signaled as single value. ltpIndex is the index of the lifting transform parameter set.

vltp_valence_update_weight_flag[ltpIndex]<del>[i]</del>—equal to 1 indicates the valence adaptive lifting update weight is performed. vltp_lifting_valence_update_weight_flag[ltpIndex]<del>[i]</del>—equal to 0 specifies the valence adaptive lifting update weight is not performed. ltpIndex is the index of the lifting transform parameter set.

Note that solutions to issues #1 and #2 may be combined.

Example #3—If the value of syntax element vltp_adaptive_update_weight_flag is equal to false, then the UpdateWeight is determined independently from the value of vltp_valence_update_flag.

Option 1: Remove this else branch entirely and remove the vltp_adaptive_update_weight_flag, because these elements duplicate the first branch of this condition.

Option 2: Fix this else branch by signaling the vltp_valence_update_weight and changing the order of signaling to match the first branch of this condition.

The syntax changes are as follows in the case of option 1:

| | Descriptor |
|---|---|
| vdmc_lifting_transform_parameters( ltpIndex, subdivisionCount ){ | |
| if( asve_lifting_offset_present_flag && ltpindex ==2 ) { | |
| vltp_lifting_main_param_flag[ ltpIndex ] | u(1) |
| for( i = 0; i < subdivisionCount [symbol] ; i++ ) { | |
| vltp_lifting_offset_values_num[ ltpIndex ][ i ] | se(v) |
| vltp_lifting_offset_values_deno_minus1[ ltpIndex ][ i ] | ue(v) |
| } | |
| } | |
| if( vltp_lifting_main_param_flag[ ltpIndex ] ) { | |
| vltp_skip_update_flag[ ltpIndex ] | u(1) |
| vltp_lod_lifting_parameter_flag[ ltpIndex ] | u(1) |
| for( i=0 ; i < subdivisionCount + 1; i++ ) { | |
| if( vltp_skip_update_flag[ ltpIndex ] ) | |
| UpdateWeight[ ltpIndex ][ i ] = 0 | |
| else { | |
| <del>vltp_adaptive_update_weight_flag[ ltpIndex ][ i ] </del> | u(1) |
| vltp_valence_update_flag[ ltpIndex ][ i ] | u(1) |
| if( vltp_lod_lifting_parameter_flag[ ltpIndex ] == 1 \|\| i == 0) { | |
| <del>if( vltp_adaptive_update_weight_flag[ ltpIndex ][ i ] ) {</del> | |
| vltp_lifting_update_weight_numerator[ ltpIndex ][ i ] | ue(v) |
| vltp_lifting_update_weight_denominator_minus1[ ltpIndex ][ i ] | ue(v) |
| UpdateWeight[ ltpIndex ][ i ] = | |
| ( vltp_lifting_update_weight_numerator[ ltpIndex ][ i ] ) ÷ | |
| ( vltp_lifting_update_weight_denominator_minus1[ ltpIndex ][ i ] + 1 ) | |
| if ( vltp_valence_update_flag[ ltpIndex ][ i ] ) { | |
| vltp_valence_update_weight[ ltpIndex ][ i ] | ue(v) |
| UpdateWeight[ ltpIndex ][ i ] *= 1 ÷ | |
| (vltp_valence_update_weight[ ltpIndex ][ i ] * 0.1 ) | |
| } | |
| <del> | |
| } else { | |
| if ( vltp_valence_update_flag[ ltpIndex ][ i ] ) { | |
| UpdateWeight[ ltpIndex ][ i ] = 1 + | |
| (vltp_valence_update_weight[ ltpIndex ][ i ] * 0.1 ) | |
| } | |
| vltp_log2_lifting_update_weight[ ltpIndex ][ i ] | <del>ue(v) |
| | </del> |
| UpdateWeight[ ltpIndex ][ i ] = | |
| 1 ÷ ( 1 << vltp_log2_lifting_update_weight[ ltpIndex ][ i ] ) | |
| } | |
| </del> | |
| } else { | |
| UpdateWeight[ ltpIndex ][ i ] = UpdateWeight[ ltpIndex ][ 0 ] | |
| } | |
| } | |
| } | |
| vltp_log2_lifting_prediction_weight[ ltpIndex ] | ue(v) |
| PredictionWeight[ ltpIndex ] = 1 ÷ ( 1 << vltp_log2_lifting_prediction_weight[ ltpInde | |
| x ] ) | |
| } | |
| } | |

<del>

vltp_adaptive_update_weight_flag[ltpIndex][i] equal to 1 indicates the update weight is represented as the ratio of numerator and denominator values. vltp_adaptive_update_weigh_flag[i] equal to 0 indicates the update weight at i^{th} level of detail is signaled as single value. ltpIndex is the index of the lifting transform parameter set.

</del>

The syntax changes are as follows for Option #2:

| | Descriptor |
|---|---|
| vdmc_lifting_transform_parameters( ltpIndex, subdivisionCount ){ | |
| if( asve_lifting_offset_present_flag && ltpindex ==2 ) { | |
| vltp_lifting_main_param_flag[ ltpIndex ] | u(1) |
| for( i = 0; i < subdivisionCount [symbol] ; i++ ) { | |
| vltp_lifting_offset_values_num[ ltpIndex ][ i ] | se(v) |
| vltp_lifting_offset_values_deno_minus1[ ltpIndex ][ i ] | ue(v) |
| } | |
| } | |
| if( vltp_lifting_main_param_flag[ ltpIndex ] ) { | |
| vltp_skip_update_flag[ ltpIndex ] | u(1) |
| vltp_lod_lifting_parameter_flag[ ltpIndex ] | u(1) |
| for( i=0 ; i < subdivisionCount + 1; i++ ) { | |
| if( vltp_skip_update_flag[ ltpIndex ] ) | |
| UpdateWeight[ ltpIndex ][ i ] = 0 | |
| else { | |
| vltp_adaptive_update_weight_flag[ ltpIndex ][ i ] | u(1) |
| vltp_valence_update_flag[ ltpIndex ][ i ] | u(1) |
| if( vltp_lod_lifting_parameter_flag[ ltpIndex ] == 1 \|\| i == 0) { | |
| if( vltp_adaptive_update_weight_flag[ ltpIndex ][ i ] ) { | |
| vltp_lifting_update_weight_numerator[ ltpIndex ][ i ] | ue(v) |
| vltp_lifting_update_weight_denominator_minus1[ ltpIndex ][ i ] | ue(v) |
| UpdateWeight[ ltpIndex ][ i ] = | |
| ( vltp_lifting_update_weight_numerator[ ltpIndex ][ i ] ) ÷ | |
| ( vltp_lifting_update_weight_denominator_minus1[ ltpIndex ][ i ] + 1 ) | |
| <del> | |
| if ( vltp_valence_update_flag[ ltpIndex ][ i ] ) { | |
| vltp_valence_update_weight[ ltpIndex ][ i ] | <del>ue(v) |
| | </del> |
| UpdateWeight[ ltpIndex ][ i ] *= 1 + | |
| (vltp_valence_update_weight[ ltpIndex ][ i ] * 0.1 ) | |
| } | |
| } else { | |
| if ( vltp_valence_update_flag[ ltpIndex ][ i ] ) { | |
| UpdateWeight[ ltpIndex ][ i ] = 1 + | |
| (vltp_valence_update_weight[ ltpIndex ][ i ] * 0.1 ) | |
| } | |
| </del> | |
| vltp_log2_lifting_update_weight[ ltpIndex ][ i ] | ue(v) |
| UpdateWeight[ ltpIndex ][ i ] = | |
| 1 ÷ ( 1 << vltp_log2_lifting_update_weight[ ltpIndex ][ i ] ) | |
| } | |
| <add> | |
| if ( vltp_valence_update_flag[ ltpIndex ][ i ] ) { | |
| vltp_valence_update_weight[ ltpIndex ][ i ] | <add>ue(v) |
| | </add> |
| UpdateWeight[ ltpIndex ][ i ] *= 1 ÷ | |
| (vltp_valence_update_weight[ ltpIndex ][ i ] * 0.1 ) | |
| } | |
| </add> | |
| } | |
| } | |
| vltp_log2_lifting_prediction_weight[ ltpIndex ] | ue(v) |
| PredictionWeight[ ltpIndex ] = 1 ÷ ( 1 << vltp_log2_lifting_prediction_weight[ | |
| ltpIndex ] ) | |
| } | |
| } | |

The semantics are unmodified.

vltp_valence_update_weight[ltpIndex][i] indicates the weighting coefficients used for the valence adaptive lifting update of the wavelet transform of the i^{th} level of detail. ltpIndex is the index of the lifting transform parameter set.

vltp_log2_lifting_update_weight[ltpIndex][i] indicates the weighting coefficients used for the update filter of the wavelet transform of the i^{th} level of detail. ltpIndex is the index of the lifting transform parameter set.

In a fourth example, this disclosure describes a simplification of valence weight calculation and reducing the number of update weight cases with a two flag solution.

The specification text of lifting transform parameters in v9.0 of VDMC is as follows:

| | Descriptor |
|---|---|
| vdmc_lifting_transform_parameters( ltpIndex, subdivisionCount ){ | |
| vltp_skip_update_flag[ ltpIndex ] | u(1) |
| for( i = 0 ; i < subdivisionCount + 1; i++ ) { | |
| if( vltp_skip_update_flag[ ltpIndex ] ) { | |
| UpdateWeight[ ltpIndex ][ i ] = 0 | |
| } else { | |
| if( i == 0 ) { | |
| vltp_lod_lifting_parameter_flag[ ltpIndex ] | u(1) |
| vltp_adaptive_update_weight_flag[ ltpIndex ] | u(1) |
| vltp_valence_update_flag[ ltpIndex ] | u(1) |
| } | |
| if( vltp_lod_lifting_parameter_flag[ ltpIndex ] == 1 \|\| i == 0) { | |
| if( vltp_adaptive_update_weight_flag[ ltpIndex ] ) { | |
| vltp_lifting_update_weight_numerator[ ltpIndex ][ i ] | ue(v) |
| vltp_lifting_update_weight_denominator_minus1[ ltpIndex ][ i ] | ue(v) |
| UpdateWeight[ ltpIndex ][ i ] = | |
| ( vltp_lifting_update_weight_numerator[ ltpIndex ][ i ] ) ÷ | |
| ( vltp_lifting_update_weight_denominator_minus1[ ltpIndex ][ i ] + 1 ) | |
| if ( vltp_valence_update_flag[ ltpIndex ] ) { | |
| vltp_valence_update_weight[ ltpIndex ][ i ] | ue(v) |
| UpdateWeight[ ltpIndex ][ i ] *= 1 + | |
| (vltp_valence_update_weight[ ltpIndex ][ i ] * 0.1 ) | |
| } | |
| } else { | |
| if ( vltp_valence_update_flag[ ltpIndex ] ) { | |
| vltp_valence_update_weight[ ltpIndex ][ i ] | ue(v) |
| UpdateWeight[ ltpIndex ][ i ] = 1 + | |
| (vltp_valence_update_weight[ ltpIndex ][ i ] * 0.1 ) | |
| } else { | |
| vltp_log2_lifting_update_weight[ ltpIndex ][ i ] | ue(v) |
| UpdateWeight[ ltpIndex ][ i ] = | |
| 1 ÷ ( 1 << vltp_log2_lifting_update_weight[ ltpIndex ][ i ] ) | |
| } | |
| } | |
| } else { | |
| UpdateWeight[ ltpIndex ][ i ] = UpdateWeight[ ltpIndex ][ 0 ] | |
| } | |
| } | |
| } | |
| vltp_log2_lifting_prediction_weight[ ltpIndex ] | ue(v) |
| PredictionWeight[ ltpIndex ] = 1 ÷ ( 1 << vltp_log2_lifting_prediction_weight[ lt | |
| pIndex] ) | |
| } | |

The above signaling allows to choose from 8 different values of update weight in lifting transform based on the value of vltp_lod_lifting_parameter_flag, vltp_adaptive_update_weight_flag and vltp_valence_update_flag. The 8 different update weight values that can be chosen is listed in the table below:

| | Lod Lifting | | | |
|---|---|---|---|---|
| Cases | Param Flag | Adaptive | Valence | Weights |
| 1 | 1 | 0 | 0 | {⅛, ⅛, ⅛} |
| 2 | | 0 | 1 | {1.4, 1.4, 1.4} |
| 3 | | 1 | 0 | { 1/16, ⅛, ¼} |
| 4 | | 1 | 1 | { 9/16, ¾, 1/1}*1.4 |
| 5 | 0 | 0 | 0 | {⅛} |
| 6 | | 0 | 1 | {1.4} |
| 7 | | 1 | 0 | { 1/16} |
| 8 | | 1 | 1 | { 9/16}*1.4 |

In some examples, the following simplifications can be made to the lifting transform syntax. Once examples is a simplification of valence-based formula which uses a valence constant. When valence is on, the update is calculated as follows:

$$\begin{matrix}const auto d 1 = updateWeight [ it ] * valenceWeight 1 * signal [ v ] ; \\ const auto d 2 = updateWeight [ it ] * valenceWeight 2 * signal [ v ] ;\end{matrix}$$

where,

$$updateWeight [ it ] = \frac{( double ) adaptiveUpdateWeightNr [ it ]}{( double ) ( adaptiveUpdateWeightDrMinus 1 [ it ] + 1} * ( 1. + valenceUpdateWeight * 0.1 )$$

$$adaptiveUpdateWeightNr = \{ 9 , 3 , 1 \}$$

$$adaptiveUpdateWeightDrMinus 1 = \{ 15 , 3 , 0 \}$$

$$valenceUpdateWeight = 4$$

The above equation can be simplified as:

$$updateWeight [ it ] = \frac{( double ) adaptiveUpdateWeightNr [ it ]}{( double ) ( adaptiveUpdateWeightDrMinus 1 [ it ] + 1}$$

Where,

$$\begin{matrix}adaptiveUpdateWeightNr = \{ 63 , 21 , 7 \} \\ adaptiveUpdateWeightDrMinus 1 = \{ 80 , 20 , 5 \}\end{matrix}$$

Here, the valence constant is dissolved into the fractional update weights and simplifies the syntax table by not having to signal vltp_valence_update_weight.

In another examples, the total number of cases may be reduced to still to cover all cases.

The option in Example 3 reduces the number of cases to perform update operations by removing vltp_adaptive_update_weight_flag. That option may be further improved by the addition of a simplification to a valence update weight calculation formula as follows:

| | Descriptor |
|---|---|
| vdmc_lifting_transform_parameters( ltpIndex, subdivisionCount ){ | |
| vltp_skip_update_flag[ ltpIndex ] | u(1) |
| for( i = 0 ; i < subdivisionCount + 1; i++ ) { | |
| if( vltp_skip_update_flag[ ltpIndex ] ) { | |
| UpdateWeight[ ltpIndex ][ i ] = 0 | |
| } else { | |
| if( i == 0 ) { | |
| <add>vltp_lod_lifting_parameter_flag</add>[ ltpIndex ] | u(1) |
| <del>vltp_adaptive_update_weight_flag[ ltpIndex ]</del> | u(1) |
| vltp_valence_update_flag[ ltpIndex ] | u(1) |
| } | |
| if( vltp_lod_lifting_parameter_flag[ ltpIndex ] == 1 \|\| i == 0) { | |
| <del>if( vltp_adaptive_update_weight_flag[ ltpIndex ] ) {</del> | |
| vltp_lifting_update_weight_numerator[ ltpIndex ][ i ] | ue(v) |
| vltp_lifting_update_weight_denominator_minus1[ ltpIndex ] [ i ] | ue(v) |
| UpdateWeight[ ltpIndex ][ i ] = | |
| ( vltp_lifting_update_weight_numerator[ ltpIndex ][ i ] ) ÷ | |
| ( vltp_lifting_update_weight_denominator_minus1[ ltpIndex ][ i ] + 1 ) | |
| <del> | |
| if ( vltp_valence_update_flag[ ltpIndex ] ) { | |
| vltp_valence_update_weight[ ltpIndex ][ i ] | ue(v) |
| UpdateWeight[ ltpIndex ][ i ] *= 1 + | |
| (vltp_valence_update_weight[ ltpIndex ][ i ] * 0.1 ) | |
| } | |
| } else { | |
| if ( vltp_valence_update_flag[ ltpIndex ] ) { | |
| vltp_valence_update_weight[ ltpIndex ][ i ] | ue(v) |
| UpdateWeight[ ltpIndex ][ i ] = 1 + | |
| (vltp_valence_update_weight[ ltpIndex ][ i ] * 0.1 ) | |
| } else { | |
| vltp_log2_lifting_update_weight[ ltpIndex ][ i ] | ue(v) |
| UpdateWeight[ ltpIndex ][ i ] = | |
| 1 ÷ ( 1 << vltp_log2_lifting_update_weight[ ltpIndex ][ i ] ) | |
| } | |
| } | |
| </del> | |
| } else { | |
| UpdateWeight[ ltpIndex ][ i ] = UpdateWeight[ ltpIndex ][ 0 ] | |
| } | |
| } | |
| } | |
| vltp_log2_lifting_prediction_weight[ ltpIndex ] | ue(v) |
| PredictionWeight[ ltpIndex ] = 1 ÷ ( 1 << vltp_log2_lifting_prediction_weig | |
| ht[ ltpIndex] ) | |
| } | |

This syntax will have 4 cases and all cases can be covered with this signaling. The four cases are tabulated below:

| | Lod Lifting | | | |
|---|---|---|---|---|
| Cases | Param Flag | Valence | Weights | |
| 1 | 1 | 0 | { 1/16, ⅛, ¼} | |
| 2 | | 1 | { 63/80, 21/20, 7/5} | → { 9/16, ¾, 1/1}*1.4 |
| 3 | 0 | 0 | { 1/16} | |
| 4 | | 1 | { 63/80} | → { 9/16 *1.4} |

The weights for case 1 and 3 can be optimized.

A fifth examples of this disclosure may reduce the number of cases with a one flag solution.

The no. of update weight cases can be further reduced to 2 cases with one flag solution (vltp_valence_update_flag) discussed in this section. One flag solution can also be used to cover all the 8 cases.

All cases can be implemented using one flag solution.

| | Descriptor |
|---|---|
| vdmc_lifting_transform_parameters( ltpIndex, subdivisionCount ){ | |
| vltp_skip_update_flag[ ltpIndex ] | u(1) |
| for( i = 0 ; i < subdivisionCount + 1; i++ ) { | |
| if( vltp_skip_update_flag[ ltpIndex ] ) { | |
| UpdateWeight[ ltpIndex ][ i ] = 0 | |
| } else { | |
| if( i == 0 ) { | |
| <del> | u(1) |
| vltp_lod_lifting_parameter_flag[ ltpIndex ] | |
| vltp_adaptive_update_weight_flag[ ltpIndex ] | u(1) |
| </del> | |
| vltp_valence_update_flag[ ltpIndex ] | u(1) |
| } | |
| <del>if( vltp_lod_lifting_parameter_flag[ ltpIndex ] == 1 \|\| i == 0) { | |
| if( vltp_adaptive_update_weight_flag[ ltpIndex ] ) {</del> | |
| vltp_lifting_update_weight_numerator[ ltpIndex ][ i ] | ue(v) |
| vltp_lifting_update_weight_denominator_minus1[ ltpIndex ][ i ] | ue(v) |
| UpdateWeight[ ltpIndex ][ i ] = | |
| ( vltp_lifting_update_weight_numerator[ ltpIndex ][ i ] ) ÷ | |
| ( vltp_lifting_update_weight_denominator_minus1[ ltpIndex ][ i ] + 1 ) | |
| if ( vltp_valence_update_flag[ ltpIndex ] ) { | |
| vltp_valence_update_weight[ ltpIndex ][ i ] | ue(v) |
| UpdateWeight[ ltpIndex ][ i ] *= 1 + | |
| (vltp_valence_update_weight[ ltpIndex ][ i ] * 0.1 ) | |
| } | |
| <del> | |
| } else { | |
| if ( vltp_valence_update_flag[ ltpIndex ] ) { | |
| vltp_valence_update_weight[ ltpIndex ][ i ] | ue(v) |
| UpdateWeight[ ltpIndex ][ i ] = 1 + | |
| (vltp_valence_update_weight[ ltpIndex ][ i ] * 0.1 ) | |
| } else { | |
| vltp_log2_lifting_update_weight[ ltpIndex ][ i ] | ue(v) |
| UpdateWeight[ ltpIndex ][ i ] = | |
| 1 ÷ ( 1 << vltp_log2_lifting_update_weight[ ltpIndex ][ i ] ) | |
| } | |
| } | |
| } else { | |
| UpdateWeight[ ltpIndex ][ i ] = UpdateWeight[ ltpIndex ][ 0 ] | |
| } | |
| </del> | |
| } | |
| } | |
| vltp_log2_lifting_prediction_weight[ ltpIndex ] | ue(v) |
| PredictionWeight[ ltpIndex ] = 1 ÷ ( 1 << vltp_log2_lifting_prediction_weight[ lt | |
| pIndex] ) | |
| } | |

With this solution, there are two cases with valence flag off and valence flag on, as shown in the table below:

| Cases | Valence | Weights |
|---|---|---|
| 1 | 0 | ( 1/16, ⅛, ¼) |
| 2 | 1 | ( 9/16, ¾, 1/1)*1.4 |

Another variation of one flag solution would be on top of simplified formula with valence constant being implicitly present in the update weights.

| | Descriptor |
|---|---|
| vdmc_lifting_transform_parameters( ltpIndex, subdivisionCount ){ | |
| vltp_skip_update_flag[ ltpIndex ] | u(1) |
| for( i = 0 ; i < subdivisionCount + 1; i++ ) { | |
| if( vltp_skip_update_flag[ ltp Index ] ) { | |
| UpdateWeight[ ltpIndex ][ i ] = 0 | |
| } else { | |
| if( i == 0 ) { | |
| <del> | u(1) |
| vltp_lod_lifting_parameter_flag[ ltpIndex ] | |
| vltp_adaptive_update_weight_flag[ ltpIndex ] | u(1) |
| </del> | |
| vltp_valence_update_flag[ ltpIndex ] | u(1) |
| } | |
| <del> | |
| if( vltp_lod_lifting_parameter_flag[ ltpIndex ] == 1 \|\| i == 0) { | |
| if( vltp_adaptive_update_weight_flag[ ltpIndex ] ) { | |
| </del> | |
| vltp_lifting_update_weight_numerator[ ltpIndex ][ i ] | ue(v) |
| vltp_lifting_update_weight_denominator_minus1[ ltpIndex ][ i ] | ue(v) |
| UpdateWeight[ ltpIndex ][ i ] = | |
| ( vltp_lifting_update_weight_numerator[ ltpIndex ][ i ] ) ÷ | |
| ( vltp_lifting_update_weight_denominator_minus1[ ltpIndex ][ i ] + 1 ) | |
| <del> | |
| if ( vltp_valence_update_flag[ ltpIndex ] ) { | |
| vltp_valence_update_weight[ ltpIndex ][ i ] | ue(v) |
| UpdateWeight[ ltpIndex ][ i ] *= 1 + | |
| (vltp_valence_update_weight[ ltpIndex ][ i ] * 0.1 ) | |
| } | |
| } else { | |
| if ( vltp_valence_update_flag[ ltpIndex ] ) { | |
| vltp_valence_update_weight[ ltpIndex ][ i ] | ue(v) |
| UpdateWeight[ ltpIndex ][ i ] = 1 + | |
| (vltp_valence_update_weight[ ltpIndex ][ i ] * 0.1 ) | |
| } else { | |
| vltp_log2_lifting_update_weight[ ltpIndex ][ i ] | ue(v) |
| UpdateWeight[ ltpIndex ][ i ] = | |
| 1 ÷ ( 1 << vltp_log2_lifting_update_weight[ ltpIndex ][ i ] ) | |
| } | |
| } | |
| } else { | |
| UpdateWeight[ ltpIndex ][ i ] = UpdateWeight[ ltpIndex ][ 0 ] | |
| } | |
| </del> | |
| } | |
| } | |
| vltp_log2_lifting_prediction_weight[ ltpIndex ] | ue(v) |
| PredictionWeight[ ltpIndex ] = 1 ÷ ( 1 << vltp_log2_lifting_prediction_weight[ lt | |
| pIndex] ) | |
| } | |

This solution will also have 2 cases with simplified valence update weight calculation formula:

| Cases | Valence | Weights | |
|---|---|---|---|
| 1 | 0 | { 1/16, ⅛, ¼} | |
| 2 | 1 | { 63/80, 21/20, 7/5} | → { 9/16, ¾, 1/1}*1.4 |

The weights for case 1 can be further optimized.

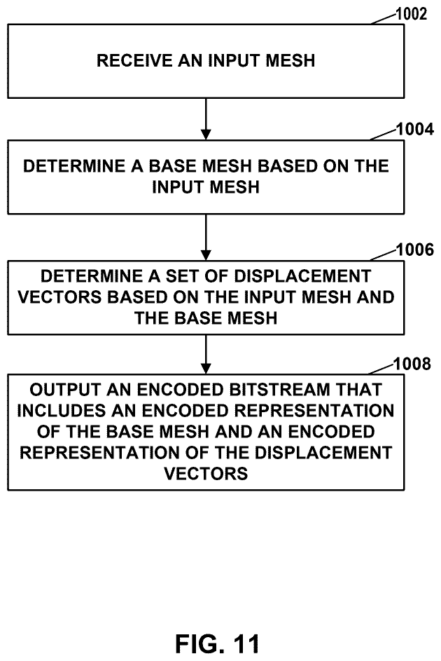

FIG. 11 is a flowchart illustrating an example process for encoding a mesh. Although described with respect to V-DMC encoder 200 (FIGS. 1 and 2), it should be understood that other devices may be configured to perform a process similar to that of FIG. 11.

In the example of FIG. 11, V-DMC encoder 200 receives an input mesh (1002). V-DMC encoder 200 determines a base mesh based on the input mesh (1004). V-DMC encoder 200 determines a set of displacement vectors based on the input mesh and the base mesh (1006). V-DMC encoder 200 outputs an encoded bitstream that includes an encoded representation of the base mesh and an encoded representation of the displacement vectors (1008). V-DMC encoder 200 may additionally determine attribute values from the input mesh and include an encoded representation of the attribute values vectors in the encoded bitstream.

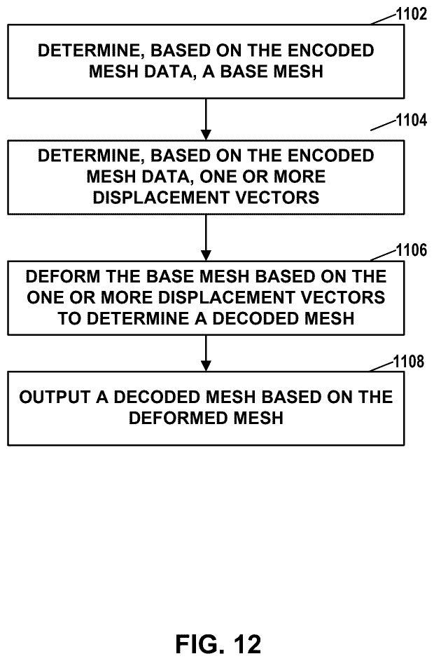

FIG. 12 is a flowchart illustrating an example process for decoding a compressed bitstream of mesh data. Although described with respect to V-DMC decoder 300 (FIGS. 1 and 3), it should be understood that other devices may be configured to perform a process similar to that of FIG. 12.

In the example of FIG. 12, V-DMC decoder 300 determines, based on the encoded mesh data, a base mesh (1102). V-DMC decoder 300 determines, based on the encoded mesh data, one or more displacement vectors (1104). V-DMC decoder 300 deforms the base mesh using the one or more displacement vectors (1106). For example, the base mesh may have a first set of vertices, and V-DMC decoder 300 may subdivide the base mesh to determine an additional set of vertices for the base mesh. To deform the base mesh, V-DMC decoder 300 may modify the locations of the additional set of vertices based on the one or more displacement vectors. V-DMC decoder 300 outputs a decoded mesh based on the deformed mesh (1108). V-DMC decoder 300 may, for example, output the decoded mesh for storage, transmission, or display.

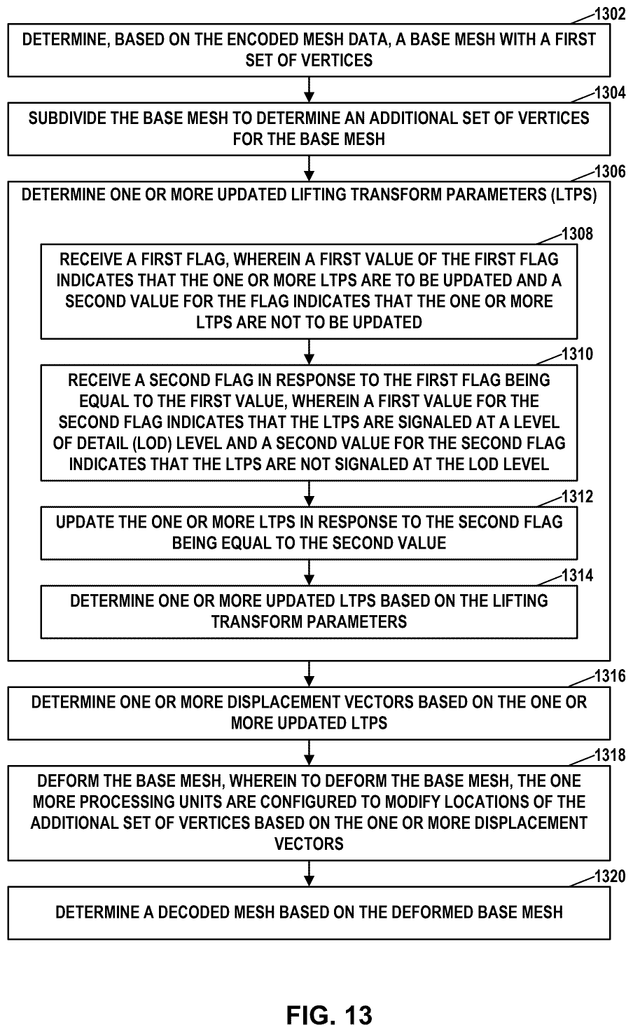

FIG. 13 is a flowchart illustrating an example process for decoding a compressed bitstream of mesh data. Although described with respect to V-DMC decoder 300 (FIGS. 1 and 3), it should be understood that other devices may be configured to perform a process similar to that of FIG. 13.

In the example of FIG. 13V-DMC decoder 300 determines, based on the encoded mesh data, a base mesh with a first set of vertices (1302). V-DMC decoder 300 subdivides the base mesh to determine an additional set of vertices for the base mesh (1304).

V-DMC decoder 300 determines one or more updated lifting transform parameters (1306). As part of determining the one or more updated lifting transform parameters, V-DMC decoder 300 receives a first flag, with a first value for the first flag indicating that the one or more lifting transform parameters are to be updated, and a second value for the flag indicating that the one or more lifting transform parameters are not to be updated (1308). The first flag may, for example, be the vltp_skip_update_flag described above.

As part of determining the one or more updated lifting transform parameters, V-DMC decoder 300 also receives a second flag in response to the first flag being equal to the first value, with a first value for the second flag indicating that lifting transform parameters are signaled at a level of detail (LoD) level, and a second value for the second flag indicating that the lifting transform parameters are not signaled at the LoD level (1310). The second flag may, for example, be the vltp_lod_lifting_parameter_flag described above. In some examples, the LoD level may be a first LoD, and the lifting transform parameters may be only signaled at the first LoD.

V-DMC decoder 300 may also receive, only for the first LoD, a third flag, with a first value for the third flag indicating that a valence adaptive lifting update weight process is performed, and a second value for the third flag indicating that the valence adaptive lifting update weight process is not performed. The third flag may, for example, be the vltp_valence_update_flag described above. V-DMC decoder 300 may update the one or more lifting transform parameters by determining update weights based on the first flag, the second flag, and the third flag.

As part of determining the one or more updated lifting transform parameters, V-DMC decoder 300 also updates the one or more lifting transform parameters in response to the second flag being equal to the second value (1312) and determines one or more updated lifting transform parameters based on the lifting transform parameters (1314).

V-DMC decoder 300 determines one or more displacement vectors based on the one or more updated lifting transform parameters (1316). V-DMC decoder 300 deforms the base mesh, wherein to deform the base mesh, the one more processing units are configured to modify locations of the additional set of vertices based on the one or more displacement vectors (1318). V-DMC decoder 300 determines a decoded mesh based on the deformed base mesh (1320).

Examples in the various aspects of this disclosure may be used individually or in any combination.

The following numbered clauses illustrate one or more aspects of the devices and techniques described in this disclosure.

Clause 1A: A device for decoding encoded mesh data, the device comprising: one or more memory units; one or more processing units implemented in circuitry, coupled to the one or more memory units, and configured to: determine, based on the encoded mesh data, a base mesh with a first set of vertices; subdividing the base mesh to determine an additional set of vertices for the base mesh; determining one or more lifting parameters according to any technique or combination of techniques in this disclosure; determine one or more displacement vectors based on the one or more lifting parameters; deform the base mesh, wherein to deform the base mesh, the one more processing units are configured to modify locations of the additional set of vertices based on the one or more displacement vectors; and determine a decoded mesh based on the deformed base mesh.

Clause 2A: The device of clause 1A, wherein the one or more processing units are further configured to determine attribute values for vertices of the decoded mesh.

Clause 3A: A device for encoding encoded mesh data, the device comprising: one or more memory units; one or more processing units implemented in circuitry, coupled to the one or more memory units, and configured to: receive an input mesh; determine a base mesh based on the input mesh; determine a set of displacement vectors based on the input mesh and the base mesh; and outputting an encoded bitstream that includes an encoded representation of the base mesh and an encoded representation of the displacement vectors.

Clause 4A: The device of clause 3A, wherein the one or more processing units are further configured to determine a set of attribute values for the input mesh and include an encoded representation of the attribute values in the encoded bitstream.

Clause 1B: A device for decoding encoded mesh data, the device comprising: one or more memory units; one or more processing units implemented in circuitry, coupled to the one or more memory units, and configured to: determine, based on the encoded mesh data, a base mesh with a first set of vertices; subdivide the base mesh to determine an additional set of vertices for the base mesh; receive a first flag, wherein a first value of the first flag indicates that one or more lifting transform parameters are to be updated and a second value for the flag indicates that the one or more lifting transform parameters are not to be updated; receive a second flag in response to the first flag being equal to the first value, wherein a first value for the second flag indicates that lifting transform parameters are signaled at a level of detail (LoD) level and a second value for the second flag indicates that the lifting transform parameters are not signaled at the LoD level; update the one or more lifting transform parameters in response to the second flag being equal to the second value; determine one or more updated lifting transform parameters based on the lifting transform parameters; determine one or more displacement vectors based on the one or more updated lifting transform parameters; deform the base mesh, wherein to deform the base mesh, the one more processing units are configured to modify locations of the additional set of vertices based on the one or more displacement vectors; and determine a decoded mesh based on the deformed base mesh.

Clause 2B: The device of clause 1B, wherein the one or more processing units are further configured to determine attribute values for vertices of the decoded mesh.

Clause 3B: The device of clause 1B or 2B, wherein the LoD level corresponds to a first LoD.

Clause 4B: The device of clause 3B, wherein the lifting transform parameters are only signaled at the first LoD.

Clause 5B: The device of clause 3B or 4B, wherein an instance of the second flag is only signaled for the first LoD.

Clause 6B: The device of any of clauses 3B-5B, wherein the one or more processing units are further configured to receive, only for the first LoD, a third flag, wherein a first value for the third flag indicates that a valence adaptive lifting update weight process is performed and a second value for the third flag indicates that the valence adaptive lifting update weight process is not performed.

Clause 7B: The device of clause 6B, wherein to update the one or more lifting transform parameters, the one or more processing units are configured to determine update weights based on the first flag, the second flag, and the third flag.

Clause 8B: The device of any of clauses 1B-7B, wherein to receive the second flag in response to the first flag being equal to the first value, the one or more processing units are further configured to only receive the second flag in response to the first flag being equal to the first value.

Clause 9B: The device of any of clauses 1B-8B, wherein the one or more processing units are further configured to: in response to the first flag being equal to the second value, infer that second flag is equal to the second value.

Clause 10B: A method for decoding encoded mesh data, the method comprising: determining, based on the encoded mesh data, a base mesh with a first set of vertices; subdividing the base mesh to determine an additional set of vertices for the base mesh; determining one or more lifting transform parameters, wherein determining the one or more lifting transform parameters comprises: receiving a first flag, wherein a first value of the first flag indicates that the one or more lifting transform parameters are to be updated and a second value for the flag indicates that the one or more lifting transform parameters are not to be updated; receiving a second flag in response to the first flag being equal to the first value, wherein a first value for the second flag indicates that lifting transform parameters are signaled at a level of detail (LoD) level and a second value for the second flag indicates that the lifting transform parameters are not signaled at the LoD level; updating the one or more lifting transform parameters in response to the second flag being equal to the second value; and determining one or more updated lifting transform parameters based on the lifting transform parameters; determining one or more displacement vectors based on the one or more updated lifting transform parameters; deforming the base mesh, wherein to deform the base mesh, the one more processing units are configured to modify locations of the additional set of vertices based on the one or more displacement vectors; and determining a decoded mesh based on the deformed base mesh.

Clause 11B: The method of clause 10B, wherein the one or more processing units are further configured to determine attribute values for vertices of the decoded mesh.

Clause 12B: The method of clause 10B or 11B, wherein the LoD level corresponds to a first LoD.

Clause 13B: The method of clause 12B, wherein the lifting transform parameters are only signaled at the first LoD.

Clause 14B: The method of clause 12B or 13B, wherein an instance of the second flag is only signaled for the first LoD.

Clause 15B: The method of any of clauses 12B-14B, further comprising: receiving, only for the first LoD, a third flag, wherein a first value for the third flag indicates that a valence adaptive lifting update weight process is performed and a second value for the third flag indicates that the valence adaptive lifting update weight process is not performed.

Clause 16B: The method of clause 15B, wherein updating the one or more lifting transform parameters comprises determining update weights based on the first flag, the second flag, and the third flag.

Clause 17B: The method of any of clauses 10B-16B, wherein receiving the second flag in response to the first flag being equal to the first value comprises only receiving the second flag in response to the first flag being equal to the first value.

Clause 18B: The method of any of clauses 10B-17B, further comprising: in response to the first flag being equal to the second value, inferring that second flag is equal to the second value.

Clause 19B: A computer-readable storage medium storing instructions that when executed by one or more processors causes the one or more processors to: determine, based on the encoded mesh data, a base mesh with a first set of vertices; subdivide the base mesh to determine an additional set of vertices for the base mesh; determine one or more lifting transform parameters, wherein to determine the one or more lifting transform parameters, the instructions cause the one or more processors to: receive a first flag, wherein a first value of the first flag indicates that the one or more lifting transform parameters are to be updated and a second value for the flag indicates that the one or more lifting transform parameters are not to be updated; receive a second flag in response to the first flag being equal to the first value, wherein a first value for the second flag indicates that lifting transform parameters are signaled at a level of detail (LoD) level and a second value for the second flag indicates that the lifting transform parameters are not signaled at the LoD level; update the one or more lifting transform parameters in response to the second flag being equal to the second value; and determine one or more updated lifting transform parameters based on the lifting transform parameters; determine one or more displacement vectors based on the one or more updated lifting transform parameters; deform the base mesh, wherein to deform the base mesh, the one more processing units are configured to modify locations of the additional set of vertices based on the one or more displacement vectors; and determine a decoded mesh based on the deformed base mesh.

Clause 20B: The computer-readable storage medium of clause 19B, wherein the instructions further cause the one or more processors to: receive, only for the first LoD, a third flag, wherein a first value for the third flag indicates that a valence adaptive lifting update weight process is performed and a second value for the third flag indicates that the valence adaptive lifting update weight process is not performed.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques may be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A device for decoding encoded mesh data, the device comprising:
one or more memory units;
one or more processing units implemented in circuitry, coupled to the one or more memory units, and configured to:
determine, based on the encoded mesh data, a base mesh with a first set of vertices;
subdivide the base mesh to determine an additional set of vertices for the base mesh;
receive a first flag, wherein a first value of the first flag indicates that one or more lifting transform parameters are to be updated and a second value for the flag indicates that the one or more lifting transform parameters are not to be updated;
receive a second flag in response to the first flag being equal to the first value, wherein a first value for the second flag indicates that lifting transform parameters are signaled at a level of detail (LoD) level and a second value for the second flag indicates that the lifting transform parameters are not signaled at the LoD level;
update the one or more lifting transform parameters in response to the second flag being equal to the second value;
determine one or more updated lifting transform parameters based on the lifting transform parameters;
determine one or more displacement vectors based on the one or more updated lifting transform parameters;
deform the base mesh, wherein to deform the base mesh, the one more processing units are configured to modify locations of the additional set of vertices based on the one or more displacement vectors; and
determine a decoded mesh based on the deformed base mesh.

2. The device of claim 1, wherein the one or more processing units are further configured to determine attribute values for vertices of the decoded mesh.

3. The device of claim 1, wherein the LoD level corresponds to a first LoD.

4. The device of claim 3, wherein the lifting transform parameters are only signaled at the first LoD.

5. The device of claim 3, wherein an instance of the second flag is only signaled for the first LoD.

6. The device of claim 3, wherein the one or more processing units are further configured to receive, only for the first LoD, a third flag, wherein a first value for the third flag indicates that a valence adaptive lifting update weight process is performed and a second value for the third flag indicates that the valence adaptive lifting update weight process is not performed.

7. The device of claim 6, wherein to update the one or more lifting transform parameters, the one or more processing units are configured to determine update weights based on the first flag, the second flag, and the third flag.

8. The device of claim 1, wherein to receive the second flag in response to the first flag being equal to the first value, the one or more processing units are further configured to only receive the second flag in response to the first flag being equal to the first value.

9. The device of claim 1, wherein the one or more processing units are further configured to:
in response to the first flag being equal to the second value, infer that second flag is equal to the second value.

10. A method for decoding encoded mesh data, the method comprising:
determining, based on the encoded mesh data, a base mesh with a first set of vertices;
subdividing the base mesh to determine an additional set of vertices for the base mesh;
determining one or more lifting transform parameters, wherein determining the one or more lifting transform parameters comprises:
receiving a first flag, wherein a first value of the first flag indicates that the one or more lifting transform parameters are to be updated and a second value for the flag indicates that the one or more lifting transform parameters are not to be updated;
receiving a second flag in response to the first flag being equal to the first value, wherein a first value for the second flag indicates that lifting transform parameters are signaled at a level of detail (LoD) level and a second value for the second flag indicates that the lifting transform parameters are not signaled at the LoD level;
updating the one or more lifting transform parameters in response to the second flag being equal to the second value; and
determining one or more updated lifting transform parameters based on the lifting transform parameters;
determining one or more displacement vectors based on the one or more updated lifting transform parameters;
deforming the base mesh, deforming the base mesh comprises modifying locations of the additional set of vertices based on the one or more displacement vectors; and
determining a decoded mesh based on the deformed base mesh.

11. The method of claim 10, further comprising:
determining attribute values for vertices of the decoded mesh.

12. The method of claim 10, wherein the LoD level corresponds to a first LoD.

13. The method of claim 12, wherein the lifting transform parameters are only signaled at the first LoD.

14. The method of claim 12, wherein an instance of the second flag is only signaled for the first LoD.

15. The method of claim 12, further comprising:
receiving, only for the first LoD, a third flag, wherein a first value for the third flag indicates that a valence adaptive lifting update weight process is performed and a second value for the third flag indicates that the valence adaptive lifting update weight process is not performed.

16. The method of claim 15, wherein updating the one or more lifting transform parameters comprises determining update weights based on the first flag, the second flag, and the third flag.

17. The method of claim 10, wherein receiving the second flag in response to the first flag being equal to the first value comprises only receiving the second flag in response to the first flag being equal to the first value.

18. The method of claim 10, further comprising:
in response to the first flag being equal to the second value, inferring that second flag is equal to the second value.

19. A computer-readable storage medium storing instructions that when executed by one or more processors causes the one or more processors to:
determine, based on encoded mesh data, a base mesh with a first set of vertices;
subdivide the base mesh to determine an additional set of vertices for the base mesh;
determine one or more lifting transform parameters, wherein to determine the one or more lifting transform parameters, the instructions cause the one or more processors to:
receive a first flag, wherein a first value of the first flag indicates that the one or more lifting transform parameters are to be updated and a second value for the flag indicates that the one or more lifting transform parameters are not to be updated;
receive a second flag in response to the first flag being equal to the first value, wherein a first value for the second flag indicates that lifting transform parameters are signaled at a level of detail (LoD) level and a second value for the second flag indicates that the lifting transform parameters are not signaled at the LoD level;
update the one or more lifting transform parameters in response to the second flag being equal to the second value; and
determine one or more updated lifting transform parameters based on the lifting transform parameters;
determine one or more displacement vectors based on the one or more updated lifting transform parameters;
deform the base mesh, wherein to deform the base mesh, the one more processing units are configured to modify locations of the additional set of vertices based on the one or more displacement vectors; and
determine a decoded mesh based on the deformed base mesh.

20. The computer-readable storage medium of claim 19, wherein the instructions further cause the one or more processors to:
receive, only for a first LoD, a third flag, wherein a first value for the third flag indicates that a valence adaptive lifting update weight process is performed and a second value for the third flag indicates that the valence adaptive lifting update weight process is not performed.
